(19) United States
(12) Patent Application Publication
(10) Pub. No.: US 2025/0386226 A1
(43) Pub. Date: Dec. 18, 2025

(54) COMMUNICATION METHOD, ACCESS NETWORK NODE, USER EQUIPMENT

(71) Applicant: NEC CORPORATION, Minato-ku, Tokyo (JP)

(72) Inventors: Caroline LIANG, Tokyo (JP); Takahiro SASAKI, Tokyo (JP)

(73) Assignee: NEC CORPORATION, Minato-ku, Tokyo (JP)

(21) Appl. No.: 18/867,502

(22) PCT Filed: Jun. 21, 2023
(86) PCT No.: PCT/JP2023/023033

§ 371 Date: Nov. 20, 2024

(30) Foreign Application Priority Data
Jun. 29, 2022 (GB) 2209589.7

(51) Int. Cl. H04W 24/10; H04L 5/00

(52) U.S. Cl. CPC H04W 24/10; H04L 5/0048

(57) ABSTRACT

A method is disclosed in which a user equipment (UE) is provided with network energy saving configuration information for energy saving at the access network node. The UE determines whether a measurement of a reference signal (RS) will be limited due to the energy saving at the access network node and the UE configures operation of the UE for the measurement of the RS, based on the determining.

### TECHNICAL FIELD

The present disclosure relates to a communication system. The disclosure has particular but not exclusive relevance to wireless communication systems and devices thereof operating according to the 3rd Generation Partnership Project (3GPP) standards or equivalents or derivatives thereof (including LTE-Advanced, Next Generation or 5G networks, future generations, and beyond). The disclosure has particular, although not necessarily exclusive relevance to, network energy saving enhancements and techniques in a radio access network.

Recent developments of the 3GPP standards are referred to as the Long Term Evolution (LTE) of Evolved Packet Core (EPC) network and Evolved UMTS Terrestrial Radio Access Network (E-UTRAN), also commonly referred as ‘4G’. In addition, the term ‘5G’ and ‘new radio’ (NR) refer to an evolving communication technology that is expected to support a variety of applications and services. Various details of 5G networks are described in, for example, the ‘NGMN 5G White Paper’ V1.0 by the Next Generation Mobile Networks (NGMN) Alliance, which document is available from https://www.ngmn.org/5g-white-paper.html. 3GPP intends to support 5G by way of the so-called 3GPP Next Generation (NextGen) radio access network (RAN) and the 3GPP NextGen core network.

### BACKGROUND ART

Under the 3GPP standards, a NodeB (or an eNB in LTE, gNB in 5G) is the radio access network (RAN) node (or simply ‘access node’ or ‘base station’) via which communication devices (user equipment or ‘UE’) connect to a core network and communicate to other communication devices or remote servers. For simplicity, the present application will use the term RAN node or base station to refer to any such access nodes.

In the current 5G architecture, for example, the gNB structure may be split into two parts known as the Central Unit (CU) and the Distributed Unit (DU), connected by an F1 interface. This enables the use of a ‘split’ architecture, whereby the, typically ‘higher’, CU layers (for example, but not necessarily or exclusively), PDCP) and the, typically ‘lower’, DU layers (for example, but not necessarily or exclusively, RLC/MAC/PHY) to be implemented separately. Thus, for example, the higher layer CU functionality for a number of gNBs may be implemented centrally (for example, by a single processing unit, or in a cloud-based or virtualised system), whilst retaining the lower layer DU functionality locally, in each of the gNB.

For simplicity, the present application will use the term mobile device, user device, or UE to refer to any communication device that is able to connect to the core network via one or more base stations. Although the present application may refer to mobile devices in the description, it will be appreciated that the technology described can be implemented on any communication devices (mobile and/or generally stationary) that can connect to a communications network for sending/receiving data, regardless of whether such communication devices are controlled by human input or software instructions stored in memory.

As 5G is becoming pervasive across industries and geographical areas, handling more advanced services and applications requiring very high data rates (e.g., extended reality (XR)), networks are: becoming denser; using more antennas; and employing larger bandwidths and a greater number of frequency bands. In this context, network energy saving is of great importance for environmental sustainability, to reduce environmental impact, and for operational cost savings. It has been reported, for example, that the energy cost of cellular networks accounts for ˜23% of the total operator cost.

### SUMMARY OF INVENTION

### Technical Problem

Much of the energy consumption in modern networks is associated with the radio access network and, in particular, the Active Antenna Unit (AAU). The power consumption for radio access can be split into two key parts: a dynamic part which is only consumed when data communication is occurring; and a static part which is consumed continuously to maintain operation of the radio access network, even when communication is not happening. Accordingly, while UE power consumption has been widely studied and considered there is also a need to consider power consumption on the network side and, in particular, for the base station.

Some techniques to facilitate base station energy saving have been defined (for example cell activation/deactivation mechanism) and some UE power saving techniques (such as discontinuous reception (DRX) and cell dormancy mechanism) may also provide some base station energy savings by careful selection of parameters. Moreover, the base station may achieve some energy saving based on appropriate configuration of the physical channels/signals and resources for UEs. However, network side energy saving has not been considered in detail at the system level.

It can be seen, therefore, that considering the environmental impact of 5G, new solutions for improving network energy savings need to be developed.

The disclosure aims to provide apparatus and related methods aimed at least partially addressing the above need.

The inventor has considered various techniques and enhancements for network energy saving. These may be grouped into a number of different broad categories including (but not limited to): time domain techniques; frequency domain techniques; spatial domain techniques; and power domain techniques.

### Solution to Problem

Possible techniques and enhancements considered for increasing time domain energy saving opportunities by the base station, include (but are not limited to):
potential methods of reducing or adapting: the transmission/reception of common channels and/or signals (such as, for example, synchronisation signal blocks (SSBs), system information blocks (e.g., SIB1), other system information (SI), paging, and/or the physical random access channel (PRACH)); and the potential impact of the transmission/reception of such common channels/signals on, for example, the initial access procedure, cell (re)selection, handover, synchronization, and/or measurements performed by the UE (idle, inactive or connected):
potential methods of reducing transmission/reception of common channels/signals can include, for example, no transmission/reception or reduced transmission/reception, increasing periodicity, on-demand transmission/reception of common channels/signals, or offloading of common channels/signals to other carriers or use of ‘light’ or ‘relaxed’ versions of common channels/signals;
potential methods of reducing/adapting transmission/reception of periodic and semi-persistent signals and channels configuration (such as, for example, channel state information reference signals (CSI-RS), group-common/UE-specific physical downlink control channel (PDCCHs), semi-persistently scheduled physical downlink shared channels (SPS PDSCHs), physical uplink control channels (PUCCHs) carrying scheduling requests (SRs), PUCCHs/PUSCHs carrying channel state information (CSI) reports, PUCCHs carrying hybrid automatic repeat request acknowledgments (HARQ-ACKs) for semi-persistent scheduling (SPS), configured grant physical uplink shared channels (CG-PUSCHs), sounding reference signals (SRSs), positioning reference signals (PRSs), etc.
semi-static and/or dynamic cell on/off in one or more granularities (e.g., subframe, slot and/or symbol granularity), for example:
Cell/network node activation request by the UE, for example using a signal/channel from UE for a base station wake-up request;
enhancements to layer 1/layer 2 (L1/L2) based mobility to efficiently enable a network node (e.g., a transmission and reception point (TRP), repeater or the like) to perform on/off operation within a cell;
signalling enhancements for indication of semi-static and/or dynamic cell/subframe/slot/symbol on/off duration;
support of periodic and/or one or more on-demand reference signals from the base station to aid discovery of a cell;
dynamic adaptation of UE connected mode discontinuous reception (C-DRX) configurations in a UE-group or cell-specific manner;
mechanisms to utilise potential energy saving states or sleep modes and the transition between states by leveraging cell on/off opportunities including:
the possibility of waking up the base station due to user traffic, or user density, or the base station receiving a wake-up signal;
the possibility of allowing discovery and measurement of cells in sleep or dormant states;
using UE assistance information to facilitate base station time domain adaptation;

It will be appreciated that all these time domain techniques are potentially applicable for single component carrier and multi-component carrier cases. Moreover, the use of UE grouping and its interaction with the above techniques has been considered.

Possible techniques and enhancements and related matters considered for frequency domain adaptation by the base station include (but are not limited to):
for operations with single-carrier or within a single component carrier (CC):
enhancements to dynamic bandwidth adaptation:
including adjustments to resource blocks (RBs) and/or bandwidth parts (BWPs) used by UEs for transmission and reception, reducing BWP switch delay, UE-group BWP switching, and joint adaptation of transmission bandwidth and power spectral density;
supporting a UE group-common BWP, a cell-specific BWP, or a dedicated BWP for network energy savings, and a related BWP switching mechanism;
enhancements for the case of frequent BWP switching such as resource configurations for SPS PDSCH and Type-2 CG PUSCH;
for operations with multi-carrier:
reduction in and/or adaption of common channels/signals for one or more CCs in multi-carrier operations:
including enablement of SSB-less secondary cell operation for one or more CCs in case of inter-band carrier aggregation (CA). For SSB-less cell operation, the conditions and restrictions required, and the related procedures, for idle, inactive or connected UEs have been considered including a secondary cell (SCell) activation procedure;
including enablement of SIB-less operation for one or more CCs in case of intra-band and inter-band CA.
reducing and/or adapting base station's transmission/reception of other common channels/signals (than SSB) and timing reference signals (TRSs) for one or more CCs;
enhancements on Scell activation and deactivation, enhancements on Scell dormancy and dynamic primary cell (Pcell) switching:
including triggering conditions and methods for signalling
activation/deactivation;
including UE group common dynamic Pcell switching.

Possible techniques and enhancements and related matters considered for the adaptation of number of spatial elements by the base station include (but are not limited to):
dynamic adaptation of spatial elements and the associated impact on UE operations, for example measurements, CSI feedback, power control, PUSCH/PDSCH repetition, SRS transmission, transmission configuration indicator (TCI) configuration, beam management, beam failure recovery, radio link monitoring, cell (re)selection, handover, initial access, etc.;
feedback/assistance information from the UE required for support dynamic spatial element adaptation:
for example, CSI measurement and reports, SR, etc
signalling methods, including reduced signalling, for enabling dynamic spatial element adaptation:
for example, group-common L1 signalling, broadcast signalling, media (or medium) access control (MAC) control elements (CEs), etc.
dynamic transmission reception point (TRxP) adaptation, for example:
triggering on/off conditions for one or more TRxPs (which could potentially be up to network implementation);
SSB, path loss reference signal (PL-RS), TRS, and CSI-RS re-configuration and the associated impact on the initial access procedure, and/or synchronization and measurements performed by the idle, inactive or connected UE
dynamic logical port adaptation and efficient port reconfigurations, for example:
signalling the port (e.g., non-zero power CSI-RS (NZP-CSI-RS) ports), if required to be known by the UE;
dynamic adaptation (including activation/deactivation) of CSI measurement or report configuration for port adaptation;
joint adaptation of spatial-domain, frequency-domain and/or power-domain configurations to avoid coverage loss;
grouping of UEs to reduce transmission and reception footprint at the base station, including (but not limited to) grouping of users in spatial domain.

It will be appreciated that spatial elements may include one or more antenna elements, transceiver units (TxRUs) (with sub-array or full-connection), antenna panels, TRxPs (co-located or geographically separated from each other), and/or logical antenna ports (corresponding to specific signals and channels).

According to one aspect there is provided a method performed by a user equipment (UE), the method comprising: receiving, from an access network node, at least one network energy saving configuration for energy saving at the access network node; identifying when the at least one network energy saving configuration has been activated; and configuring operation of the UE, based on the at least one network energy saving configuration, and when the at least one network energy saving configuration has been activated.

The at least one network energy saving configuration may include at least one of: at least one time domain configuration including a configuration of at least one time domain resource for energy saving at the access network node; at least one frequency domain configuration including a configuration of at least one frequency domain resource for energy saving at the access network node; at least one spatial domain configuration including a transmitter or receiver configuration to be applied at the access network node to provide energy saving; and at least one power domain configuration including a power configuration to be applied at the access network node to provide energy saving.

In a case that the at least one network energy saving configuration includes at least one time domain configuration, the at least one time domain configuration may defines at least one time period during which the at least one network energy saving configuration will be active.

The at least one time domain configuration may include an indication of at least one of: at least one periodicity of the at least one time period; at least one offset representing a start time of the at least one time period; at least one granularity for the at least one time period; at least one duration of the at least one time period; at least one timer value for timing the at least one time period; or at least one time of day corresponding to the at least one time period. The at least one time domain configuration may include timing information indicating at least one part of the of the at least one time period during which network energy saving will be active or inactive. The timing information may indicate at least one pattern of time domain resources within the at least one time period during which network energy saving will be active or inactive. The timing information may include at least one bitmap to indicate the at least one pattern of time domain resources. The timing information may include. The at least one time domain configuration may include a granularity for the timing information. The at least one network energy saving configuration may include a plurality of time domain configurations, each time domain configuration of the plurality of time domain configurations defining a respective time period during which that network energy saving configuration will be active, wherein the respective time period defined by each of the plurality of time domain configurations has a different respective periodicity.

The method may further comprise: determining if a reference signal to be measured will coincide with a time during which network energy saving is active; and in a case where a reference signal to be measured will coincide with a time during which network energy saving is active, excluding the reference signal to be measured from measurement.

The method may further comprise: determining if a reference signal to be transmitted will coincide with a time during which network energy saving is active; and in a case where a reference signal to be transmitted will coincide with a time during which network energy saving is active, excluding the reference signal to be transmitted from transmission.

Thee at least one network energy saving configuration may include an indication of a time at which the at least one network energy saving configuration will activated, and the identifying may be based on the indication of the time at which the at least one network energy saving configuration will activated.

In a case that the at least one network energy saving configuration includes at least one frequency domain configuration, the at least one frequency domain configuration may define a reconfiguration of at least one frequency resource that will be applied in a case where the at least one network energy saving configuration is active.

The at least one frequency domain configuration may include an indication that a reduced reference signal density will be applied in a case where the at least one network energy saving configuration is active. The indication that a reduced reference signal density will be applied may indicate a density scaling factor that is to be applied to a current reference signal density to arrive at the reduced reference signal density. The at least one frequency domain configuration may indicate at least one reduced bandwidth that is to be applied in a case where the at least one network energy saving configuration is active. The at least one frequency domain configuration may include a frequency offset indicating a start position of a bandwidth to be used by the UE within the at least one reduced bandwidth. The at least one frequency domain configuration may indicate a UE specific bandwidth part that is to be used in a case where the at least one network energy saving configuration is active. The at least one frequency domain configuration may indicate at least one bandwidth part scaling factor that is to be applied in respect of at least one bandwidth part to arrive at the at least one reduced bandwidth. The at least one frequency domain configuration may indicate a mapping between the at least one bandwidth part scaling factor and the at least one bandwidth part in respect of which the bandwidth part scaling factor is to be applied. The at least one frequency domain configuration may indicate at least one pattern of frequency domain resources which are to be active or inactive in a case where the at least one network energy saving configuration is active. The at least one frequency domain configuration may include at least one bitmap to indicate the pattern of frequency domain resources. The at least one frequency domain configuration may include a granularity for the pattern of frequency domain resources.

The UE may be configured with a default bandwidth part, wherein, in a case where the default bandwidth part is not a currently active bandwidth part, the configuring includes redefining a currently active bandwidth part configured for network energy saving as a new default bandwidth part. The UE may be configured with a default bandwidth part and an inactivity timer for timing a period of inactivity after which the UE is configured to switch back to the default bandwidth part, wherein, in a case where the default bandwidth part is not a currently active bandwidth part, the configuring includes inhibiting operation of the inactivity timer to cause the UE to continue to use a currently active bandwidth part configured for network energy saving. The UE may be configured with at least one first bandwidth part for use in a case where network energy saving is not active, and at least one second bandwidth part for use in a case where network energy saving is active, wherein the configuring may include switching from at least one first bandwidth part to at least one second bandwidth part.

The method may further comprise: receiving, from the access network node, a reference signal reporting configuration indicating at least one reference signal set for reporting to the access network node, and at least one transceiver configuration associated with the at least one reference signal set; measuring the at least one reference signal set; and reporting a result of the measuring to the access network node; wherein, in a case that the at least one network energy saving configuration includes at least one spatial domain configuration, the at least one spatial domain configuration may indicate at least one transceiver configuration selected by the access network node for network energy saving based on measurements reported by the UE for at least one reference signal set associated with the at least one transceiver configuration selected by the access network node.

The method may further comprise: receiving, from the access network node, a reference signal resource configuration indicating at least one resource set for transmission of at least one set of reference signals, and at least one receiver configuration associated with the at least one set of reference signals; transmitting, to the access network node, the at least one set of reference signals using the at least one resource set; wherein, in a case that the at least one network energy saving configuration includes at least one spatial domain configuration, the at least one spatial domain configuration may indicate at least one receiver configuration selected by the access network node for network energy saving based on measurements of at least one set of reference signals, transmitted by the UE, associated with the at least one receiver configuration selected by the access network node.

In a case that the at least one network energy saving configuration includes at least one power domain configuration, the at least one power domain configuration may indicate at least one of a power scaling factor, or a sleep mode type, to be applied at the access network node for network energy saving.

The at least one network energy saving configuration may include at least one joint configuration indicating a mapping between a plurality of different configurations, the plurality of different configurations including at least two configurations of: a time domain configuration; a frequency domain configuration; a spatial domain configuration; or a power domain configuration.

According to one aspect there is provided a user equipment (UE) comprising: means for receiving, from an access network node, at least one network energy saving configuration for energy saving at the access network node; means for identifying when the at least one network energy saving configuration has been activated; and means for configuring operation of the UE, based on the at least one network energy saving configuration, and when the at least one network energy saving configuration has been activated.

According to one aspect there is provided a method performed by an access network node, the method comprising: transmitting, to a user equipment (UE), at least one network energy saving configuration for energy saving at the access network node; identifying when the at least one network energy saving configuration is to be activated; activating the at least one network energy saving configuration; and configuring operation of the access network node, based on the at least one network energy saving configuration transmitted to the UE. According to one aspect there is provided an access network node comprising: means for transmitting, to a user equipment (UE), at least one network energy saving configuration for energy saving at the access network node; means for identifying when the at least one network energy saving configuration is to be activated; means for activating the at least one network energy saving configuration; and means for configuring operation of the access network node, based on the at least one network energy saving configuration transmitted to the UE.

### BRIEF DESCRIPTION OF DRAWINGS

Example embodiments of the disclosure will now be described, by way of example, with reference to the accompanying drawings in which:

FIG. 1 schematically illustrates a mobile (‘cellular’ or ‘wireless’) telecommunication system of FIG. 1;

FIG. 2 illustrates a typical frame structure that may be used in the telecommunication system of FIG. 1;

FIG. 3 is a schematic block diagram illustrating the main components of a UE for the telecommunication system of FIG. 1;

FIG. 4 is a schematic block diagram illustrating the main components of a base station for the telecommunication system of FIG. 1;

FIG. 5 is a simplified timing diagram illustrating a procedure, which may be implemented in the telecommunication system of FIG. 1;

FIG. 6 is a simplified timing diagram illustrating another procedure, which may be implemented in the telecommunication system of FIG. 1;

FIG. 7 is a simplified illustration of how time domain network energy saving may be implemented in the procedure of FIG. 6;

FIG. 8 is a simplified timing diagram illustrating another procedure, which may be implemented in the telecommunication system of FIG. 1;

FIG. 9 is a simplified timing diagram illustrating another procedure, which may be implemented in the telecommunication system of FIG. 1;

FIG. 10 is a simplified timing diagram illustrating another procedure, which may be implemented in the telecommunication system of FIG. 1;

FIG. 11 is a simplified timing diagram illustrating another procedure, which may be implemented in the telecommunication system of FIG. 1;

FIG. 12 is a simplified timing diagram illustrating another procedure, which may be implemented in the telecommunication system of FIG. 1; and

FIG. 13 is a simplified timing diagram illustrating another procedure, which may be implemented in the telecommunication system of FIG. 1.

### DESCRIPTION OF EMBODIMENTS

### Overview

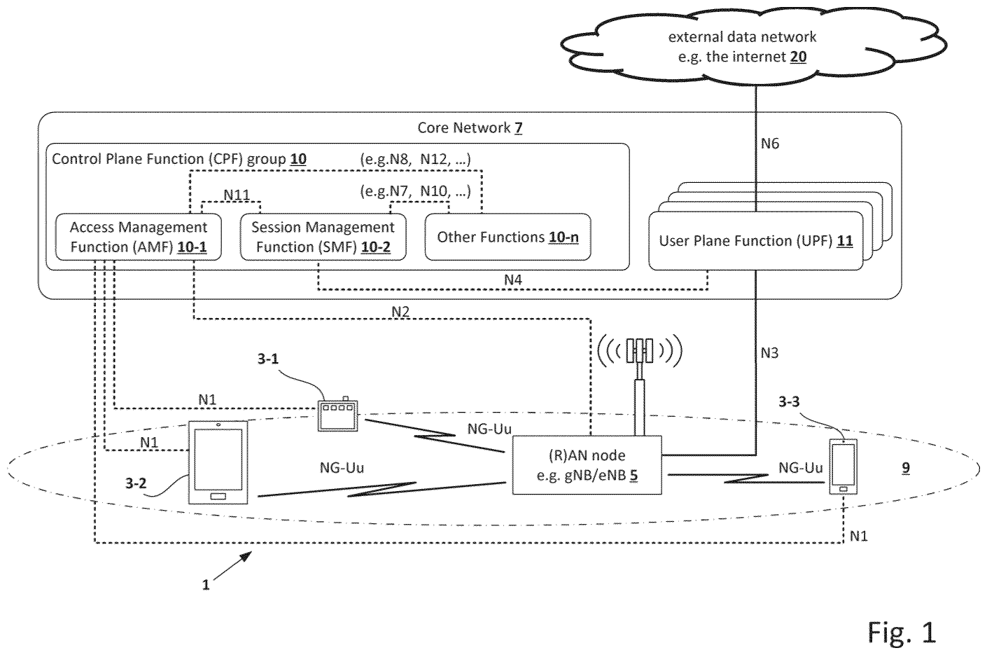

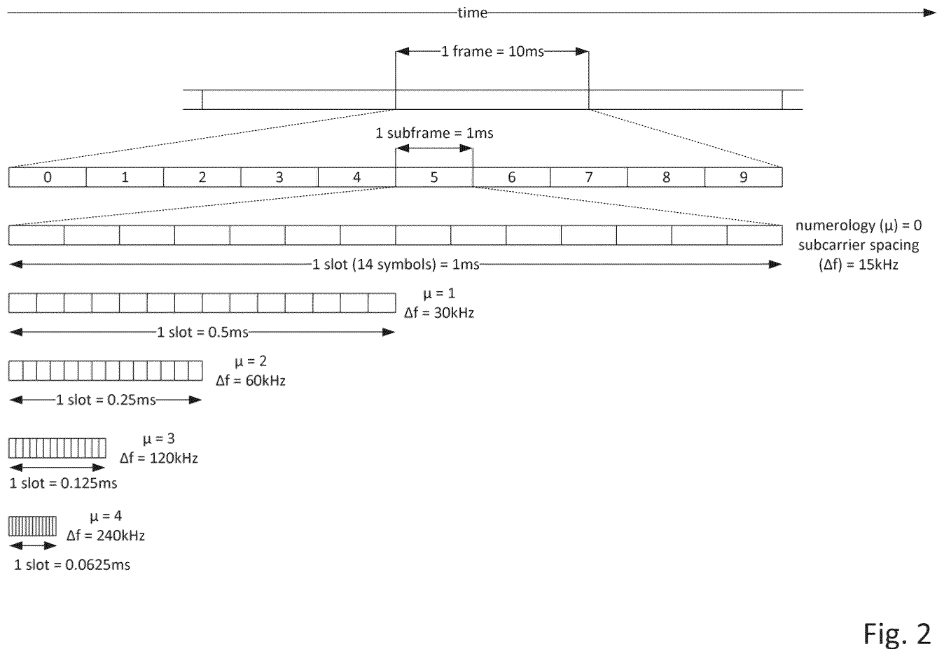

An exemplary telecommunication system will now be described, by way of example only, with reference to FIG. 1 and FIG. 2.

FIG. 1 schematically illustrates a mobile (‘cellular’ or ‘wireless’) telecommunication system 1 to which example embodiments of the present disclosure are applicable.

In the network 1 user equipment (UEs) 3-1, 3-2, 3-3 (e.g., mobile telephones and/or other mobile devices) can communicate with each other via a radio access network (RAN) node 5 that operates according to one or more compatible radio access technologies (RATs). In the illustrated example, the RAN node 5 comprises a NR/5G base station or ‘gNB’ 5 operating one or more associated cells 9. Communication via the base station 5 is typically routed through a core network 7 (e.g., a 5G core network or evolved packet core network (EPC)).

As those skilled in the art will appreciate, whilst three UEs 3 and one base station 5 are shown in FIG. 1 for illustration purposes, the system, when implemented, will typically include other base stations and UEs.

Each base station 5 controls one or more associated cells either directly, or indirectly via one or more other nodes (such as home base stations, relays, remote radio heads, distributed units, and/or the like). It will be appreciated that the base stations 5 may be configured to support both 4G and 5G, and/or any other 3GPP or non-3GPP communication protocols.

The UEs 3 and their serving base station 5 are connected via an appropriate air interface (for example the so-called ‘Uu’ interface and/or the like). Neighbouring base stations 5 may be connected to each other via an appropriate base station to base station interface (such as the so-called ‘X2’ interface, ‘Xn’ interface and/or the like).

The core network 7 includes a number of logical nodes (or ‘functions’) for supporting communication in the telecommunication system 1. In this example, the core network 7 comprises control plane functions (CPFs) 10 and one or more user plane functions (UPFs) 11. The CPFs 10 include one or more Access and Mobility Management Functions (AMFs) 10-1, one or more Session Management Functions (SMFs) and a number of other functions 10-n.

The base station 5 is connected to the core network nodes via appropriate interfaces (or ‘reference points’) such as an N2 reference point between the base station 5 and the AMF 10-1 for the communication of control signalling, and an N3 reference point between the base station 5 and each UPF 11 for the communication of user data. The UEs 3 are each connected to the AMF 10-1 via a logical non-access stratum (NAS) connection over an N1 reference point (analogous to the S1 reference point in LTE). It will be appreciated, that N1 communications are routed transparently via the base station 5.

One or more UPFs 11 are connected to an external data network (e.g., an IP network such as the internet) via reference point N6 for communication of the user data.

The AMF 10-1 performs mobility management related functions, maintains the non-NAS signalling connection with each UE 3 and manages UE registration. The AMF 10-1 is also responsible for managing paging. The SMF 10-2 provides session management functionality (that formed part of MME functionality in LTE) and additionally combines some control plane functions (provided by the serving gateway and packet data network gateway in LTE). The SMF 10-2 also allocates IP addresses to each UE 3.

Referring to FIG. 2, which illustrates the typical frame structure that may be used in the telecommunication system 1, the base station 5 and UEs 3 of the telecommunication system 1 communicate with one another using resources that are organised, in the time domain, into frames of length 10 ms. Each frame comprises ten equally sized subframes of 1 ms length. Each subframe is divided into one or more slots comprising 14 Orthogonal frequency-division multiplexing (OFDM) symbols of equal length.

As seen in FIG. 2, the telecommunication system 1 supports multiple different numerologies (subcarrier spacing (SCS), slot lengths and hence OFDM symbol lengths). Specifically, each numerology is identified by a parameter, p, where μ=0 represents 15 kHz (corresponding to the LTE SCS). Currently, the SCS for other values of μ can, in effect, be derived from μ=0 by scaling up in powers of 2 (i.e., SCS=15×2^{μ} kHz). The relationship between the parameter, μ, and SCS (Δf) is as shown in Table 1:

TABLE 1
5G Numerology

| | | Number of slots | Slot |
|---|---|---|---|
| μ | Δf = 2^{μ} · 15 [kHz] | per subframe | length (ms) |
| 0 | 15 | 1 | 1 |
| 1 | 30 | 2 | 0.5 |
| 2 | 60 | 4 | 0.25 |
| 3 | 120 | 8 | 0.125 |
| 4 | 240 | 16 | 0.0625 |

In the communication system 1 the cell bandwidth can be divided into multiple bandwidth parts (BWPs) that each start at a respective common resource block (RB) and respectively comprises of a set of contiguous RBs with a given numerology (sub-carrier spacing, ‘SCS’, and cyclic prefix, ‘CP’) on a given carrier. It will be appreciated that conventionally the number of downlink symbols, uplink symbols, and flexible symbols in each slot of the slot configuration (e.g., common or dedicated) would be common to each configured BWP.

The UEs 3 and base station 5 of the communication system 1 are thus configured for operation using BWPs. For each serving cell of a UE 3, the base station 5 can configure at least one downlink (DL) BWP (e.g., an initial DL BWP). The base station 5 may configure the UE 3 with up to a maximum (typically four) further DL BWPs with only a single DL BWP being active at a given time. The UE 3 is not expected to receive PDSCH, PDCCH, or CSI-RS (except for radio resource management (RRM)) outside an active bandwidth part. Where the serving cell is configured with an uplink (UL), the base station 5 can configure at least one UL BWP (e.g., an initial UL BWP). The base station 5 may configure the UE 3 with up to a maximum (typically four) further UL BWPs with only one UL BWP being active at a given time. The UE 3 does not transmit PUSCH or PUCCH outside an active bandwidth part. For an active cell, the UE 3 does not transmit SRS outside an active bandwidth part.

A BWP identifier or index (BWP-ID) is used to refer to BWPs (in UL and DL independently). Various radio resource control (RRC) configuration procedures can thus use the BWP-ID to associate themselves with a particular BWP.

Specifically, the base station 5 is able to configure an initial DL BWP (e.g., by means of an initialDownlinkBWP IE) via system information (e.g., system information block 1, ‘SIB1’) and/or via dedicated (e.g., RRC) signalling (e.g., an RRC reconfiguration, RRC resume, or RRC setup message). For example, the common parameters for the initial DL BWP may be provided via system information whereas UE specific parameters may be provided via dedicated signalling (e.g., in a ServingCellConfig IE within an RRC message that contains a dedicated, UE-specific, BWP configuration). The dedicated signalling may also contain some cell-specific information which may be useful for specific scenarios (e.g., handover).

The base station 5 is able to configure an initial UL BWP (e.g., by means of an initialUplinkBWP IE) via system information (e.g., system information block 1, ‘SIB1’) and/or via dedicated (e.g., RRC) signalling (e.g., an RRC reconfiguration, RRC resume, or RRC setup message). For example, the common parameters for one or more initial UL BWPs may be provided via system information whereas UE specific parameters may be provided via dedicated signalling (e.g., in a ServingCellConfig IE within an RRC message that contains a dedicated, UE-specific, BWP configuration). This provides configuration information either for a so-called special cell (SpCell)—which is a PCell of a master cell group (MCG) or secondary cell group (SCG)—or a secondary cell (SCell).

The initial DL and UL BWPs are used at least for initial access before an RRC connection is established. The initial BWP is known as BWP #0 as it has a BWP identifier (or ‘index’) of zero. Prior to receiving system information defining a UE's initial DL BWP, the DL BWP for each UE 3 has a frequency range and numerology corresponding to a control resource set (CORESET)—e.g., CORESET #0—defined by a master information block (MIB) (or possibly dedicated RRC signalling). The CORESET is used to carry downlink control information (DCI) transmitted via a physical downlink control channel (PDCCH) for scheduling system information blocks.

After receiving the system information (e.g., SIB1) a UE 3 uses the BWP configuration defined by that system information to configure the initial DL BWP and initial UL BWP. The configured initial UL BWP is then used to initiate a random-access procedure for setting up an RRC connection. The base station 5 configures the frequency domain location and bandwidth of the initial DL BWP in the system information so that the initial DL BWP contains the entire CORESET #0 in the frequency domain.

For each DL BWP in a set of DL BWPs for a primary cell, a UE 3 can be configured with CORESETs for every type of common search space (CSS) set and for a UE-specific search space (USS) set. For each UL BWP in a set of UL BWPs of a primary cell, or of a PUCCH-secondary cell, the UE 3 is configured with resource sets for PUCCH transmissions.

The further DL BWPs and further UL BWPs may be configured by downlink BWP information and uplink BWP information provided via dedicated signalling (e.g., respectively in a BWP-Downlink IE and BWP-Uplink IE of the ServingCellConfig IE within an RRC message).

The downlink BWP information includes, for example: an identifier (or index) of the BWP being configured (e.g., a BWP-ID IE); common downlink BWP information (e.g., a BWP-DownlinkCommon IE) for configuring the common parameters (cell-specific) of a downlink BWP; and dedicated BWP information (e.g., a BWP-DownlinkDedicated IE) for configuring the dedicated (UE specific) parameters of a downlink BWP.

The dedicated downlink BWP information includes information for configuring a UE specific PDCCH (e.g., a PDCCH-Config IE) for the BWP, and information for configuring a UE specific PDSCH (e.g., a PDSCH-Config IE) for the BWP. Configurations for the CORESET and the CSI-RS are also configured via the dedicated downlink BWP information (the CORESET via the PDCCH Configuration and the CSI-RS via the PDSCH configuration).

The uplink BWP information includes, for example: an identifier (or index) of the BWP being configured (e.g., a BWP-ID IE or BWPIndex); common uplink BWP information (e.g., a BWP-UplinkCommon IE) for configuring the common parameters (cell-specific) of a uplink BWP; and dedicated BWP information (e.g., a BWP-UplinkDedicated IE) for configuring the dedicated (UE specific) parameters of a uplink BWP. The dedicated uplink BWP information includes information for configuring a UE specific PUCCH (e.g., a PUCCH-Config IE) for the BWP, and information for configuring a UE specific PUSCH (e.g., a PUSCH-Config IE) for the BWP.

The starting position and bandwidth of a DL BWP is defined via respective location and bandwidth information (e.g., a ‘locationAndBandwidth’ IE) of the corresponding common downlink BWP information of the downlink BWP information as identified by identifier (or index) of the BWP being configured (e.g., a BWP-ID IE or BWPIndex).

The starting position and bandwidth of a UL BWP is defined via respective location and bandwidth information (e.g., a ‘locationAndBandwidth’ IE) of the corresponding common uplink BWP information of the uplink BWP information as identified by identifier (or index) of the BWP being configured (e.g., a BWP-ID IE or BWPIndex).

The UE 3 is configured for switching its active BWP between its configured BWPs when required. For example, switching at the UE 3 may be initiated by receipt of a scheduling DCI, by expiry of an inactivity timer (e.g., a BWPInactivityTimer), and/or by initiation of a random-access procedure.

For typical use cases, an idle mode BWP (such as an initial BWP) is smaller than a connected mode BWPs. In addition to the initial BWP there are two main UE specific types of BWP, namely the first active BWP and the default BWP. Like the initial BWP, the first active BWP may also be used to perform initial access. The first active BWP is also the first BWP where a UE 3 starts data transfer after RRC configuration/reconfiguration. The default BWP, when configured for a UE, is a UE specific BWP that the corresponding UE should switch back to when the inactivity timer expires. If a default BWP is not configured for a UE than the initial BWP may be treated as the default BWP.

Beneficially, the telecommunication network 1 implements a number of advantageous techniques and enhancements for implementing network energy saving (NES) configurations at the base station 5 and for related coordination of communication between the UE 3 and the base station to take account of the NES configurations at the base station. These techniques and enhancements include time domain, frequency domain, spatial domain and power domain techniques. It will, nevertheless, be appreciated that NES benefits may be achieved without implementing all the techniques and enhancements described. In particular, benefits may be achieved by only implementing a time domain NES technique, a frequency domain NES technique, a spatial domain NES technique, or a power domain NES technique, or a subset of such techniques.

In more detail, the base station 5 and UE 3 are mutually configured to support implementation of an NES mode in the time, frequency, spatial, and/or power domain. As described in more detail later, the base station 5 configures the NES mode (or updates the NES configuration) and notifies the UE 3 of the of the (updated) NES configuration by using appropriate signalling (e.g., RRC signalling) to signal information elements (IEs) to the UE 3 that define the various aspects of the NES configuration in the time, frequency, spatial, and/or power domain and thus preconfigure the NES mode at the UE 3. An appropriate NES configuration is activated at the base station 5 appropriately when NES is enabled. The relevant IEs forming part of that NES configuration will then be applied autonomously whenever the base station 5 enters into a corresponding NES mode until the NES configuration is updated.

The UE 3 is able to identify when a particular NES configuration (whether a time, frequency, spatial, or power domain configuration or a ‘joint’ configuration representing a combination of such configurations) is to be activated (if inactive) or deactivated (if active) at the base station 5.

The timing of NES configuration activation/deactivation may be, for example, determined based on explicit signalling (e.g., dynamically via an NES activation indication in downlink control information (DCI)). For example, two bits of an NES field in a DCI may be used for dynamic activation of a specific NES configuration (e.g., a preconfigured time, frequency, spatial, and/or power domain configuration).

Specifically, different bit combinations (binary values) may be used to activate/deactivate different configuration types at the UE (e.g., 00—time; 01—frequency; 10—spatial; 11—power). It will be appreciated that it is also possible that two or more different configurations (e.g., time, frequency, spatial, power) may be activated simultaneously using a four-bit DCI field where each bit represents activation/deactivation. Alternatively, a single bit may be used to indicate that all semi-statically configured NES configurations (which have not been released) will be activated upon time domain activation of network energy saving.

It will be appreciated, however, that activation/deactivation may alternatively or additionally be identified implicitly, for example based on the stored NES configuration information. Implicit activation/deactivation may, for example, be based on activation (or deactivation) after expiry of a delay timer/period (e.g., T_{NES}) representing a delay between the configuration of NES and the start timing for activation/deactivation of an NES configuration (especially for semi-static activation of NES).

Implicit activation/deactivation may, for example, be based on activation (or deactivation) for a predetermined time period during the day or night, deactivation (or activation) after expiry of a timer or triggered by the occurrence of a particular event, periodic activation (or deactivation) at a regular preconfigured interval, deactivation (or activation) for a specific duration after activation (or deactivation), or the like).

As described in more detail later, the telecommunication network 1 implements a number of advantageous techniques and enhancements for providing flexible time domain energy saving in which both the UE 3 and base station 5 are able to identify the timings at which energy saving is active within the network. Based on this, the base station 5 and/or UE 3 are able to work out if specific instances of non-zero power CSI-RS (NZP-CSI-RS) (or sounding reference signals (SRS)) are to be excluded from measurement/reporting at the UE 3 (or base station 5) by determining if the NZP-CSI-RS (or SRS) falls within the duration of the identified NES timing during which NES is active at the base station 5.

In one beneficial technique described in more detail later, the NES configuration provided to the UE 3 comprises time domain configuration information that includes a configurable periodicity and offset defining a regularly (periodically) occurring window during which an energy saving NES mode is active. The time domain configuration in the exemplary communication system 1 also defines one or more time domain patterns that define specific timings (e.g., a slot, group of slots, or other time period) during the NES window during which NES is active or inactive. The periodicity, offset and time domain pattern may be defined at any suitable level of timing granularity (which may change between releases and generations of communication technology).

In another beneficial technique, the time domain configuration information (alternatively or additionally) includes information identifying a predetermined duration, a timer value, and/or a time of day representing a period during which NES will be active. In this case the UE 3/base station 5 will know implicitly when the NES is no longer active and hence no explicit deactivation is then needed. This is particularly suitable for a scenario in which there is known/recurring user traffic only for a certain period (e.g., user traffic occurs at specific timings and/or for specific durations).

Beneficially, the base station 5 of the communication system 1, may also be configured for simultaneous activation and/or deactivation of a plurality of configurations of time domain energy saving transmissions (for example, a time domain pattern having a long periodicity and a time domain pattern having a short periodicity). Specifically, one configuration (e.g., short periodicity) can be activated at the same time as another one (e.g., long periodicity) is activated. Plural different configurations may also be activated or deactivated independently.

This provides the flexibility for the base station 5 to achieve a greater degree of power saving, while having the ability to respond quickly to data arrival, especially when there are multiple different traffic characteristics. The different time domain configurations may, for example, form part of a list defining a plurality of NES configurations that may be used to configure multiple NES configurations simultaneously.

As described in more detail later, the telecommunication network 1 also implements a few advantageous techniques and enhancements for providing a configurable network energy saving pattern in the frequency domain.

Beneficially, in one technique described in more detail below, the NES configuration provided to the UE 3 comprises frequency domain configuration information that includes information defining a reduced CSI-RS density. CSI-RS is a flexible multi-purpose signal that can be used for beam management. During the network energy saving mode, however, beam refinement may not be supported and frequent RRC reconfiguration is undesirable. Accordingly, the reduced density can be indicated as part of the NES configuration for the frequency domain. This reduced density can then be applied autonomously (at the base station 5 and UE 3) every time the base station 5 enters into the NES mode, until the NES configuration is updated.

It will be understood here that, assuming the transmit power for the resource element is fixed, the overall transmit power will nevertheless be reduced due to the reduction in the number of resource elements used for transmission. Beneficially, this has no impact for legacy UEs.

In another beneficial technique described in more detail below, the frequency domain configuration information (alternatively or additionally) is configured for defining a reduced NES bandwidth and the UE 3 performs UE-BWP switching to operate within the NES bandwidth (if needed), when NES is activated. The reduced bandwidth for NES is signalled to the UE via the NES configuration. Beneficially the base station 5 may also define one or more new NES BWPs within the NES bandwidth. The NES BWP may be a UE specific BWP defined specifically for NES to be used if the active BWP of the UE needs to be changed for operation within the reduced NES bandwidth. Alternatively (or additionally) the NES BWP may be an ‘effective NES BWP’ defined by a start offset (which can be relative to the start position of the configured NES bandwidth) with the remaining parameters (e.g., configuring the length of the BWP, the CORESET, the CSI-RS etc.) reused, albeit shifted in the frequency domain by the offset. In this scenario, any part of the BWP/CORESET/CSI-RS which extends outside of the NES bandwidth will be excluded.

In another beneficial technique, the frequency domain configuration information (alternatively or additionally) is configured for semi-static, or dynamic, BWP switching/adaptation for adapting the UE configuration to different traffic activity. Specifically, certain frequency resources of a BWP (e.g., resource blocks/resource block groups) may be (re)configured, and/or specific BWPs may be (re)configured, for the purposes of BWP adaptation for NES. The frequency resources/BWPs may be configured for all UEs or for a ‘group’ of one or more UEs.

The frequency domain configuration information may, for example, include information for configuring a scaling factor, and/or a frequency domain bitmap ‘energy saving’ pattern, for BWP adaptation when entering the NES mode. If a frequency domain bitmap is used this may provide an indication of frequency resources (e.g., at a granularity of one or more resource block groups (RBGs)) used within a union of group common BWPs (where each BWP is a number of contiguous RBGs). For example, a ‘1’ in the frequency domain pattern bitmap may indicate an active frequency resource, and a ‘0’ a deactivated frequency resource (or vice versa).

This frequency domain configuration may, as described in more detail later, be provided via an RRC (re)configuration. A group common DCI or a media access control element (MAC CE) may also be enhanced to include a scaling factor and/or frequency domain pattern for faster (dynamic) activation/deactivation of an NES mode in which the scaling factor and/or frequency domain pattern is applied. As described in more detail later, one or more bandwidth scaling factors may be used to configure one or more reduced scale NES BWPs for a particular UE 3 to be used when the NES configuration is active. An advantage of the ‘bandwidth scaling factor’ is that to enter into the NES mode and use the NES BWP, no dedicated BWP switching signalling is needed for each individual UE.

While the base station 5 can currently use dedicated signalling to configure up to 4 DL BWP per cell and up to 4 UL BWP per cell, in an optional (but beneficial) enhancement the communication system 1 supports configuration of one or more additional DL NES-BWPs per cell and one or more additional UL NES-BWPs per cell, while operating in an NES mode.

As described in more detail later, the telecommunication network 1 also implements a number of advantageous techniques and enhancements for providing spatial domain network energy saving.

Specifically, in one beneficial example, the base station 5 generates one or more hypothetical transceiver (TRX) on/off configurations, for a group of one or more UEs, which is used for determining an appropriate TRX configuration for network energy saving. A respective set of ports (such as 64/32/8/4) and one or more associated CSI-RS configurations can then be determined for each hypothetical TRX on/off configuration. The UEs 3 measure and report the respective CSI-RS corresponding to the TRX configuration, allowing the base station 5 to identify the best of the directional beams, and hence select the associated TRX ports, to turn on/off. The TRX configuration for NES can then be (re)configured by mapping the selected TRX ports setting to an associated index in spatial domain configuration information provided as part of the NES configuration. A field for this index is also added to each group of NZP-CSI-RS configurations for reference signal resource configuration and measurement reporting in information for configuring the CSI reporting.

In the uplink, as described in more detail later, a similar technique can be implemented for measurement, at the base station 5, of SRS transmitted by the UE 3.

The telecommunication network 1 also beneficially provides for power domain network energy saving.

Beneficially, the NES configuration provided to the UE 3 comprises power domain configuration information that includes information defining a power scaling factor that will be applied during NES and/or information indicating a sleep mode in which the base station 5 may operate when NES is activated. The information indicating a sleep mode may identify a sleep mode ‘type’ based on power level only (such as micro sleep, light sleep or deep sleep). The power domain configuration information may also identify one or more specific cells for which the sleep mode is to be applied, and/or the timing of a wake up cycle from sleep mode.

It will be appreciated that the information elements in the NES configuration need not be confined to a single one of the time, frequency, spatial and power domains. The NES configuration may, for example, include information for joint adaptation of the frequency domain, spatial domain, power domain and/or time domain when NES is active.

In one specific example, a mapping table may be included that defines a mapping between a TRX index representing a particular TRX port on/off setting (as described above), a BWP index (e.g., corresponding to a BWP to which the TRX port on/off setting relates), and an associated power scaling factor that will be applied in respect of TRXs that remain on.

### User Equipment

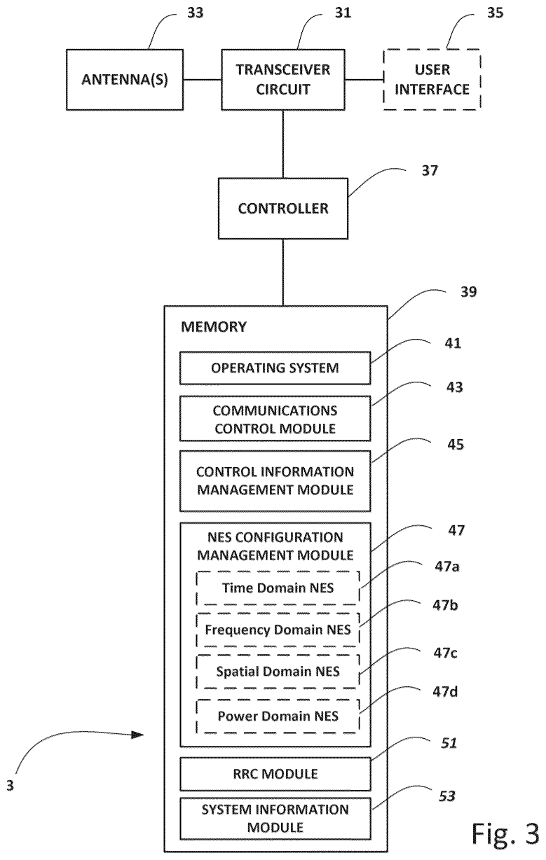

FIG. 3 is a schematic block diagram illustrating the main components of a UE 3 for the communication system 1 shown in FIG. 1.

As shown, the UE 3 has a transceiver circuit 31 that is operable to transmit signals to and to receive signals from a base station 5 via one or more antenna 33. The UE 3 has a controller 37 to control the operation of the UE 3. The controller 37 is associated with a memory 39 and is coupled to the transceiver circuit 31. Although not necessarily required for its operation, the UE 3 might, of course, have all the usual functionality of a conventional UE 3 (e.g., a user interface 35, such as a touch screen/keypad/microphone/speaker and/or the like for, allowing direct control by and interaction with a user) and this may be provided by any one or any combination of hardware, software and firmware, as appropriate. Software may be pre-installed in the memory 39 and/or may be downloaded via the telecommunications network or from a removable data storage device (RMD), for example.

The controller 37 is configured to control overall operation of the UE 3 by, in this example, program instructions or software instructions stored within memory 39. As shown, these software instructions include, among other things, an operating system 41, a communications control module 43, a control information management module 45, an NES configuration management module 47, an RRC module 51, and a system information module 53.

The communications control module 43 is operable to control the communication between the UE 3 and its serving one or more base stations 5 (and other communication devices connected to the base station 5, such as further UEs and/or core network nodes). The communications control module 43 is configured for the overall handling uplink communications via associated uplink channels (e.g., via a physical uplink control channel (PUCCH) and/or a physical uplink shared channel (PUSCH)) including both dynamic and semi-static signalling (e.g., SRS). The communications control module 43 is also configured for the overall handling of receipt of downlink communications via associated downlink channels (e.g., via a physical downlink control channel (PDCCH) and/or a physical downlink shared channel (PDSCH)) including both dynamic and semi-static signalling (e.g., CSI-RS). The communications control module 43 is responsible for determining the resources to be used by the UE 3, to determine how frequency resources and/or slots/symbols are configured (e.g., for UL communication, DL communication, or the like), and to determine which one or more bandwidth parts are configured for the UE 3.

The control information management module 45 is responsible for managing the tasks related to the reception of downlink control information (DCI) from the base station.

The RRC module 51 is responsible for the reception of RRC signalling from the base station 5, and the transmission of RRC signalling to the base station 5.

The NES configuration management module 47 is responsible for maintaining up-to-date information regarding one or more network energy saving configurations implemented in the network and, in particular, at the base station 5. These configurations may, for example, include one or more of the following: one or more time domain NES configurations 47a; one or more frequency domain NES configurations 47b; one or more spatial domain NES configurations 47c and/or one or more power domain NES configurations 47d. The NES configuration management module 47 is also responsible for identifying when a particular NES configuration (whether a time, frequency, spatial, or power domain configuration or a ‘joint’ configuration representing a combination of such configurations) is to be activated (if inactive) or deactivated (if active) at the base station 5. The timing of NES configuration activation/deactivation may be determined based on explicit signalling (e.g., dynamically via an NES activation indication in DCI) or implicitly based on the stored NES configuration information. Implicit activation/deactivation may, for example, be based on activation (or deactivation) for a predetermined time period during the day or night, deactivation (or activation) after expiry of a timer or triggered by the occurrence of a particular event, periodic activation (or deactivation) at a regular preconfigured interval, deactivation (or activation) for a specific duration after activation (or deactivation), or the like).

The system information module 53 is responsible for the reception and interpretation of system information from the base station 5.

### Base Station

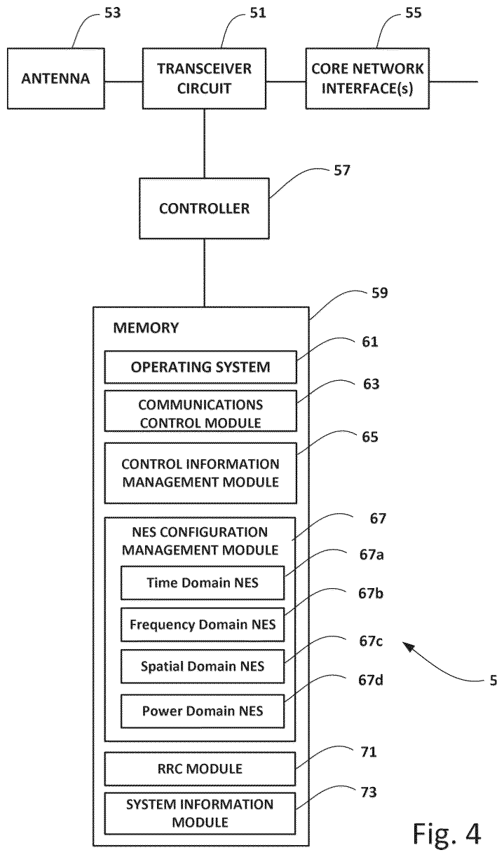

FIG. 4 is a schematic block diagram illustrating the main components of the base station 5 for the communication system 1 shown in FIG. 1. As shown, the base station 5 has a transceiver circuit 51 for transmitting signals to and for receiving signals from the communication devices (such as UEs 3) via one or more antenna 53 (e.g., an antenna array/massive antenna), and a core network interface 55 (e.g., comprising the N2, N3 and other reference points/interfaces) for transmitting signals to and for receiving signals from network nodes in the core network 7. Although not shown, the base station 5 may also be coupled to other base stations via an appropriate interface (e.g., the so-called ‘Xn’ interface in NR). The base station 5 has a controller 57 to control the operation of the base station 5. The controller 57 is associated with a memory 59. Software may be pre-installed in the memory 59 and/or may be downloaded via the communications network 1 or from a removable data storage device (RMD), for example. The controller 57 is configured to control the overall operation of the base station 5 by, in this example, program instructions or software instructions stored within memory 59.

As shown, these software instructions include, among other things, an operating system 61, a communications control module 63, a control information management module 65, an NES configuration management module 67, an RRC module 71, and a system information module 73.

The communications control module 63 is operable to control the communication between the base station 5 and UEs 3 and other network entities that are connected to the base station 5. The communications control module 63 is configured for the overall control of the reception of uplink communications, via associated uplink channels (e.g., via a physical uplink control channel (PUCCH) and/or a physical uplink shared channel (PUSCH)) including both dynamic and semi-static signalling (e.g., SRS). The communications control module 43 is also configured for the overall handling the transmission of downlink communications via associated downlink channels (e.g., via a physical downlink control channel (PDCCH) and/or a physical downlink shared channel (PDSCH)) including both dynamic and semi-static signalling (e.g., CSI-RS).

The control information management module 65 is responsible for managing the tasks related to the transmission of downlink control information from the base station.

The NES configuration management module 67 is responsible for generating, maintaining, and notifying the UE 3 of, one or more network energy saving configurations implemented in the network and, in particular, at the base station 5. These configurations may, for example, include one or more of the following: one or more time domain NES configurations 67a; one or more frequency domain NES configurations 67b; one or more spatial domain NES configurations 67c and/or one or more power domain NES configurations 67d. The NES configuration management module 67 is also responsible for identifying when a particular NES configuration (whether a time, frequency, spatial, or power domain configuration or a ‘joint’ configuration representing a combination of such configurations) is to be activated (if inactive) or deactivated (if active) at the base station 5 and, if necessary, notifying the UE 3 accordingly. The timing of NES configuration activation/deactivation may be notified to the UE 3 explicitly (e.g., dynamically via an NES activation indication in DCI). The timing of NES configuration activation/deactivation may be notified implicitly based on the NES configuration information provided to the UE 3. Implicit activation/deactivation may, for example, be based on activation (or deactivation) for a predetermined time period during the day or night, deactivation (or activation) after expiry of a timer or triggered by the occurrence of a particular event, periodic activation (or deactivation) at a regular preconfigured interval, deactivation (or activation) for a specific duration after activation (or deactivation), or the like).

The RRC module 71 is responsible for the reception of RRC signalling from UE 3, and the transmission of RRC signalling to the UE 3.

The system information module 73 is responsible for the transmission of system information to UEs in the base station's one or more cells 9.

### Configuration of Network Energy Saving

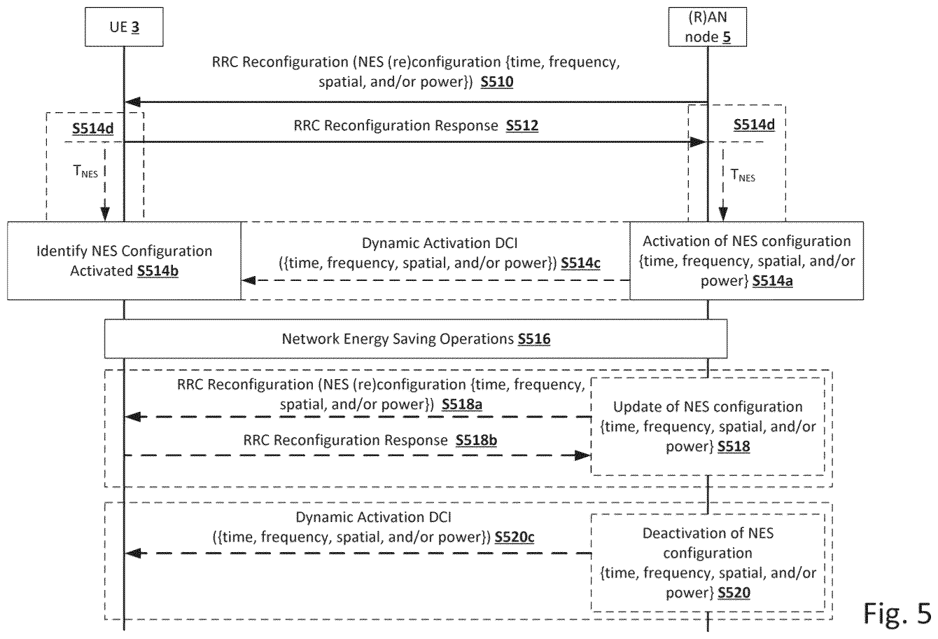

A generalised method for configuring network energy saving will now be described in more detail, by way of example only, with reference to FIG. 5.

FIG. 5 is a simplified timing diagram illustrating a procedure, which may be implemented in the telecommunication system 1 of FIG. 1, for configuring network energy saving at the UE 3.

As seen in FIG. 5 when the base station 5 determines that NES needs to be implemented, the base station 5 sends (at S510), to the UE 3, an RRC reconfiguration message carrying information for configuring (or reconfiguring) NES at the UE 3 indicating an (updated) NES configuration).

The NES (re)configuration information may comprise information representing a time domain NES configuration, information representing a frequency domain NES configuration, information representing a spatial domain NES configuration, and/or information representing a power domain NES configuration (or any combination of such information). The NES (re)configuration information may comprise joint configuration information, e.g., for mapping specific aspects of one configuration to those of another. For example, NES (re)configuration information may comprise joint configuration information identifying a respective particular power scaling factor to be applied by the base station 5 in respect of each of a plurality of transceiver on/off configurations for providing corresponding energy saving beam patterns, and/or each of a plurality of BWPs (possibly at a particular timing). Moreover, the NES configuration information may comprise a list defining a plurality of NES configurations (e.g., an NESConfig-List IE).

Examples of specific time domain, frequency domain, spatial domain, and power domain configurations, and associated information elements, are described in more detail below. Purely by way of example, however, the NES configuration may comprise:
Time Domain NES configuration information:
Information identifying a periodicity and timing offset (e.g., a PeriodicityAndOffset IE) defining the start of a timing window during which NES will be activated (for at least some slots/symbols);
Information, such as a bitmap, defining one or more time domain patterns or a sequence of such patterns (e.g., a Sequence <TimeDomainPatternBitmap> IE), and information identifying a timing offset (e.g., a respective Offset IE for each time domain pattern), for identifying specific slots (or symbols) of the timing window during which NES will be activated and/or specific slots (or symbols) of the timing window during which NES will be deactivated;
Information indicating one or more timer values (e.g., T_{NES}) for timing a delay between configuration (or some other event if appropriate) and activation (or deactivation) occurs; and/or
Information indicating the duration of the timing window (alternatively the duration may be fixed or determined implicitly).
Frequency Domain NES configuration information:
Information identifying a reduced NES bandwidth (e.g., an NESLocationAndBandwidth IE) in the frequency domain;
Information identifying one or more new UE specific BWPs specifically for NES (e.g., an NESBWP IE);
Information identifying an offset relative to the reduced NES bandwidth (e.g., an NESBWPOffset IE) in the frequency domain;
Information indicating that a reduced CSI-density will be applied and possibly indicating the reduced CSI-density absolutely (e.g., 1, 0.5, . . . ) or relatively (e.g., ⅓, ½, . . . );
Information indicating one or more BWP scaling factors to be applied, information identifying the NES BWP corresponding to each BWP scaling factor, and/or information identifying an existing BWP in respect of which each scaling factor is to be applied (e.g., a BWPIndex IE); and/or
Information identifying an energy saving frequency domain pattern.
Spatial Domain NES configuration information:
Information identifying a specific transceiver port setting for an energy saving beam configuration (e.g., TRX ports (64/32/8/4) IE);
Information identifying one or more CSI-RS configurations which may be turned on or off (e.g., a CSI-RS configuration (ON/OFF) IE); and/or
Information identifying an index associated with a particular transceiver configuration to be implemented for NES at the base station (e.g., a TRXPoolIndex IE) that maps to a particular reference signal (e.g., NZP-CSI-RS) configuration in a reference signal report configuration provided separately.
Power Domain NES configuration information:
Information identifying a power scaling factor that will be applied for base station transmissions; and/or
Information defining a sleep mode that will be applied at the base station 5.

The UE 3 stores the (updated) configuration information and sends and appropriate RRC reconfiguration response message to the base station 5 at S512. The RRC reconfiguration response may, for example, be an RRC reconfiguration complete message.

The ‘network side’ NES configuration is then activated at the base station 5, at S514a, after receipt of the RRC reconfiguration response message. It will be appreciated that activation need not happen immediately but may happen at any suitable juncture. The UE 3 identifies when the activation at the base station 5 occurs, at S514b, and uses the stored NES configuration information to identify how the UE 3 should apply the NES configuration to adapt its own operations (e.g., communication and/or measurement operations) while NES is activated. In effect the UE 3 activates the NES configuration at the UE 3 (‘UE side’ NES) albeit that the main actions for network energy saving occur in, and are controlled by, the network.

The UE 3 can identify when activation will occur implicitly, for example based on the NES (re)configuration information stored at the UE 3. For example, activation may occur after a configured delay (e.g., indicated by T_{NES}) between configuration of NES and the start of activation (as seen at S514d). It will be appreciated that while, in the procedure of FIG. 5, the delay is shown, for illustrative purposes, as being timed from transmission/reception of the RRC response message, the delay may be timed from any appropriate juncture (possibly with an appropriate timing offset applied at the UE and/or base station to ensure the start of the delay is properly synchronised between the UE and base station).

It will be appreciated, however, that NES may be activated explicitly by signalling from the base station 5. For example, as shown at S514c the NES configuration (or a specific time, frequency, spatial, and/or power domain part of it) may be activated at the UE 3 by means of an appropriately formatted ‘dynamic activation’ DCI or the like. For example, two bits of an NES field in the activation DCI may be used for dynamic activation of a specific NES configuration (e.g., a preconfigured time, frequency, spatial, and/or power domain configuration).

Once the NES configuration is activated at the base station 5 and UE 3, NES operations between the base station 5 and the UE 3 commence at S516. These NES operations continue until the NES configuration is updated as indicated at S518 or deactivated as indicated at S520. In the case of NES configuration update, the base station 5 sends (as indicated at S518a), to the UE 3, an RRC reconfiguration message carrying information for reconfiguring (updating) the NES configuration stored at the UE 3. The UE 3 updates the stored NES configuration and responds with an appropriate RRC reconfiguration response at S518b, as described above.

In the case of deactivation, the UE 3 can identify when deactivation will occur implicitly, for example based on the NES (re)configuration information stored at the UE 3. It will be appreciated, however, that the NES configuration may be deactivated explicitly by signalling from the base station 5. For example, as shown at S520c the NES configuration (or a specific time, frequency, spatial, and/or power domain part of it) may be deactivated at the UE 3 by means of an appropriately formatted ‘dynamic activation’ DCI or the like. For example, the two bits of the NES field in the activation DCI described above may also be used for dynamic deactivation of a specific NES configuration (e.g., a preconfigured time, frequency, spatial, and/or power domain configuration).

It will be appreciated that when configuring/updating the NES mode the network does not need to indicate a full set of IEs, only the relevant IEs need be provided in the time, frequency, spatial, and/or the power domain. This may, for example, be only the IEs required for a particular type (time/frequency/spatial/power) of energy saving, or only those IEs representing a change from a previous configuration notified to the UE 3.

### Time Domain Network Energy Saving

### Indicating Time Domain Energy Saving Patterns

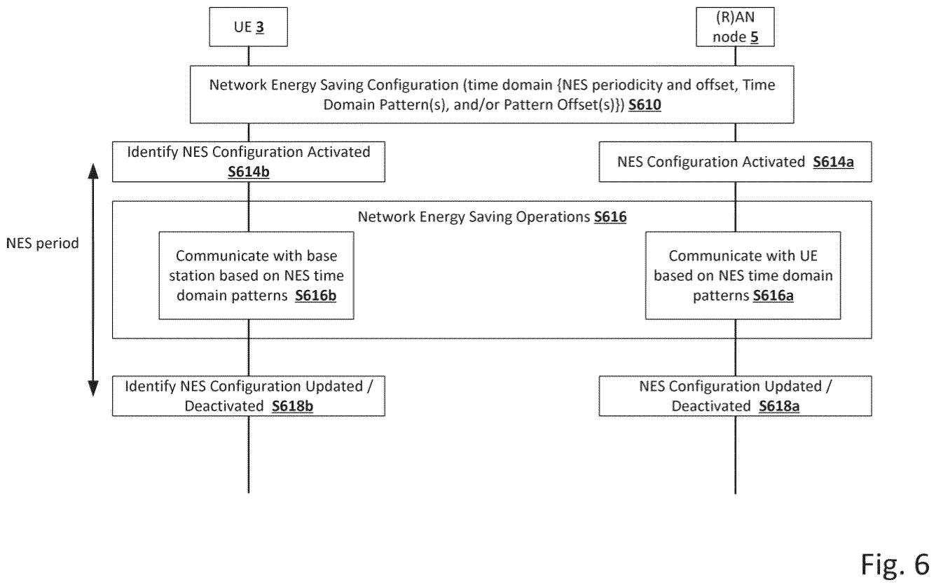

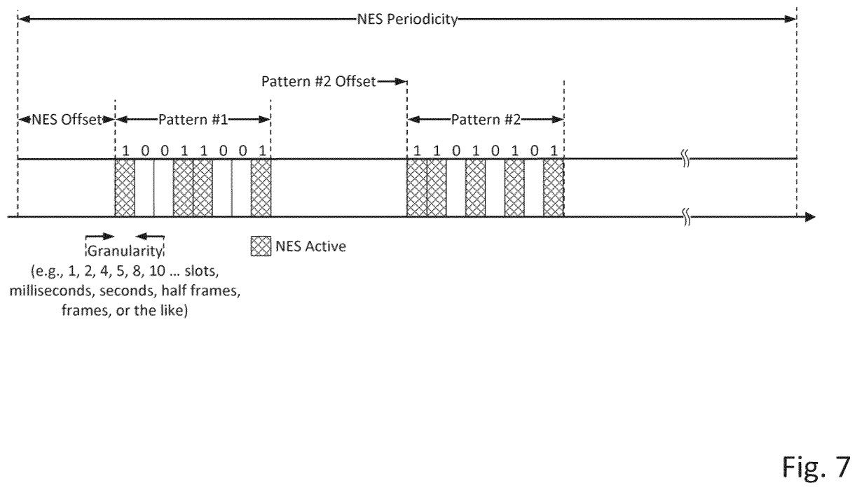

A generalised method for configuring time domain network energy saving will now be described in more detail, by way of example only, with reference to FIG. 6 and FIG. 7.

FIG. 6 is a simplified timing diagram illustrating a procedure, which may be implemented in the telecommunication system 1 of FIG. 1, for configuring time domain network energy saving at the UE 3 (e.g., as part of the procedure of FIG. 5).

As seen in FIG. 6, the base station 5 provides (updated) NES configuration information to the UE 3 at S610 which stores the information and responds appropriately (e.g., as described with reference to FIG. 5). In this example, the NES configuration information comprises time domain energy saving information indicating an NES periodicity and offset (e.g., a periodicityAndOffset IE) defining a regularly (periodically) occurring window (NES period).

During this NES period the NES configuration is activated, although specific NES operations at the base station 5 may be activated/deactivated for only part of that NES period (e.g., within specific slots, groups of slots, half frames, frames, or the like). The time domain configuration also defines one or more time domain patterns that define the specific timings during the NES period during which network energy saving operations are to be active or inactive. The time domain pattern may, for example, be signalled by means of an appropriate bitmap (e.g., a TimeDomainPatternBitmap IE). Moreover, a ‘sequence’ type IE may be used to define a sequence of one or more time domain configurations (e.g., a Seq<TimeDomainPatternBitmap> IE).

Referring to FIG. 7, which is a simplified illustration of how time domain network energy saving may be implemented in the procedure of FIG. 5, for each time domain pattern, the respective bitmap may, for example, use a bit set to ‘1’ to represent a time period (e.g., a slot, group of slots, or other time period) during which NES is active and a bit set to ‘0’ to represent a time period (e.g., a slot, group of slots, or other time period) during which NES is inactive (or vice versa). While the start of each pattern configured by a respective bitmap may be predefined (e.g., to be at set intervals within the NES period), information defining an offset (e.g., relative to the start/end of the NES period, or relative to the start/end of the previous pattern), may be provided as part of the NES configuration information.

The periodicity, offset and time domain pattern may be defined at any suitable level of timing granularity (which may change between releases and generations of communication technology). The granularity may, itself, be configurable (e.g., as part of the NES configuration information). The granularity of the periodicity and/or pattern may, for example, be configurable in multiples of frames, milliseconds, or seconds (e.g. {1, 2, 4, 5, 8, 10 . . . }). The configurable periodicities may, for example, include multiples of one or more ‘5 ms’ (or half frames) or ‘10 ms’ (or radio frames). The granularity of the periodicity and/or pattern may also be configurable in multiples of symbols, or slots (e.g., {1, 2, 4, 5, 8, 10, . . . }).

The ‘network side’ NES configuration is then activated at the base station 5, at S614a, at the start of the NES period defined by the time domain energy saving information indicating an NES periodicity and offset. The UE 3 identifies when the activation at the base station 5 occurs, at S614b, and uses the stored NES configuration information to identify the specific timings when NES operations are active/inactive and hence adapt its own operations (e.g., communication and/or measurement operations) appropriately while the NES configuration is activated.

It will be appreciated that the configuration of the NES period does not preclude NES activation using other explicit or implicit methods as described previously, for example, activation after a configured delay between configuration of NES and the start of activation and/or dynamic activation at the UE 3 by means of an appropriately formatted ‘dynamic activation’ DCI or the like.

Once the NES configuration is activated at the base station 5 and UE 3, NES operations between the base station 5 and the UE 3 commence at S616. In this example, the operations include performing communications between (and possibly measurements of reference signals at) the UE 3 and base station 5 based on the NES time domain patterns indicated in the NES configuration information (at S616a and S616b).

The NES operations continue until the NES configuration is deactivated (or updated) as indicated at S618a and S618b (e.g., as described with reference to FIG. 5).

### Application of Time Domain Energy Saving in Respect of Reference Signals

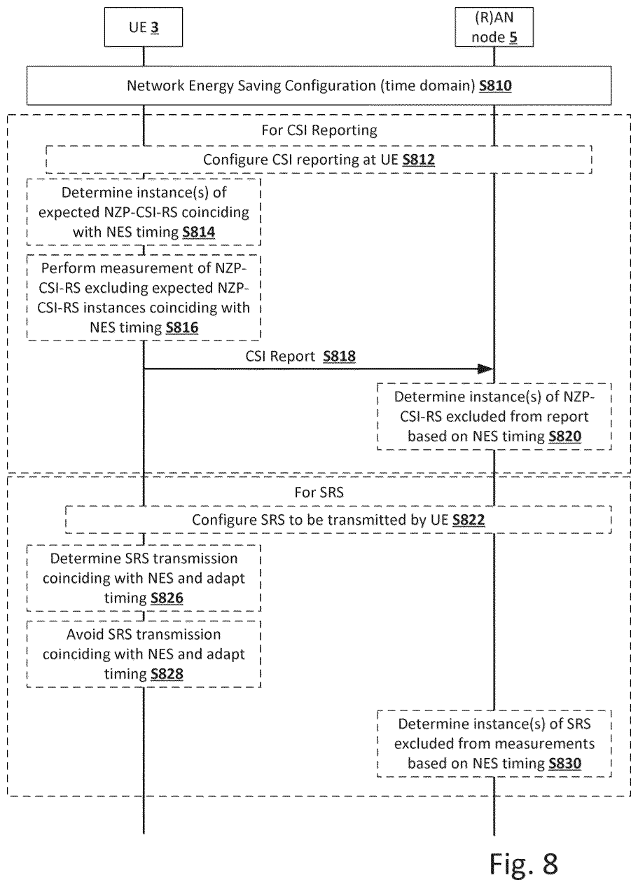

A generalised method illustrating how for time domain energy saving may be applied in respect of reference signals will now be described in more detail, by way of example only, with reference to FIG. 8.

FIG. 8 is a simplified timing diagram illustrating a procedure, which may be implemented in the telecommunication system 1 of FIG. 1, for configuring reference signals and/or reference signal measurements while NES is activated (e.g., as part of the procedure of FIG. 5).

As seen in FIG. 8, the base station 5 provides (updated) NES configuration information to the UE 3 at S810 which stores the information and responds appropriately (e.g., as described with reference to FIG. 5). In this example, the NES configuration information comprises time domain energy saving information indicating a time domain NES configuration (e.g., as described with reference to FIG. 6).

For the purpose of CSI-Reporting, when CSI reporting is configured at the UE 3 by the base station 5 (at S812), the UE 3 determines (at S814), based on the time domain NES configuration, and the reporting configuration, instances of expected NZP-CSI-RS that occur during an NES timing duration (e.g., times during which NES operations are active). The UE 3 can then perform (at S816) measurement of NZP-CSI-RS while excluding instances of expected NZP-CSI-RS that occur during an NES timing duration. The results are then reported to the base station 5 at S818. The base station 5 is able to determine any instances of NZP-CSI-RS that will be excluded from the received report, based on the time domain NES configuration (as indicated at S820).

For the purpose of SRS measurements, when SRS resources are configured at the UE 3 by the base station 5 (at S822), the UE 3 determines (at S826), based on the time domain NES configuration, and the reporting configuration, instances of SRS transmissions that will occur during an NES timing duration (e.g., times during which NES operations are active). The UE 3 can then avoid (as indicated at S828) SRS transmission that would occur during an NES timing duration. The base station 5 is also able to determine any instances of SRS that will be avoided and perform SRS measurements accordingly (as indicated at S830).

### Configuring a Specific Time Period for Network Energy Saving

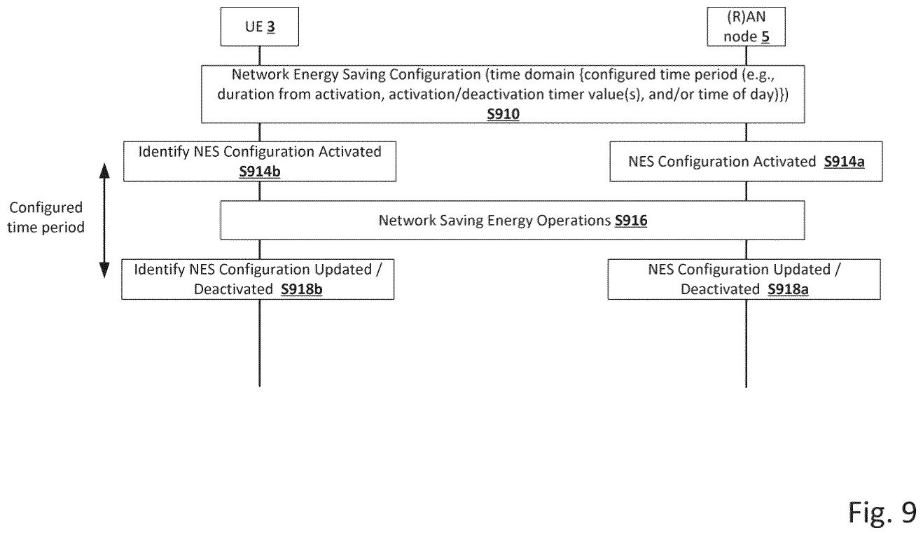

Another generalised method for configuring time domain network energy saving will now be described in more detail, by way of example only, with reference to FIG. 9.

FIG. 9 is a simplified timing diagram illustrating another procedure, which may be implemented in the telecommunication system 1 of FIG. 1, for configuring time domain network energy saving at the UE 3 (e.g., as part of the procedure of FIG. 5).

As seen in FIG. 9, the base station 5 provides (updated) NES configuration information to the UE 3 at S910 which stores the information and responds appropriately (e.g., as described with reference to FIG. 5). In this example, the NES configuration information comprises time domain energy saving information defining one or more configured time periods during which the NES configuration will be active (or inactive). The information may, for example, define a duration (e.g., from activation or some other timing), one or more activation/deactivation timer values, and/or a specific time period during the day, week, month, year, and/or the like.

The NES configuration is then activated at the base station 5 (at S914a) and UE 3 (at S914b) at the start of the configured time period defined by the time domain energy saving information.

It will be appreciated that the configuration of the configure time period does not preclude NES activation using other explicit or implicit methods as described previously, for example, activation after a configured delay between configuration of NES and the start of activation and/or dynamic activation at the UE 3 by means of an appropriately formatted ‘dynamic activation’ DCI or the like.

Once the NES configuration is activated at the base station 5 and UE 3, NES operations between the base station 5 and the UE 3 take place at S916.

The NES operations continue until the NES configuration is deactivated (or updated) as indicated at S918a and S918b (e.g., as described with reference to FIG. 5).

### Frequency Domain Network Energy Saving

### Indicating Reduced CSI-RS Density

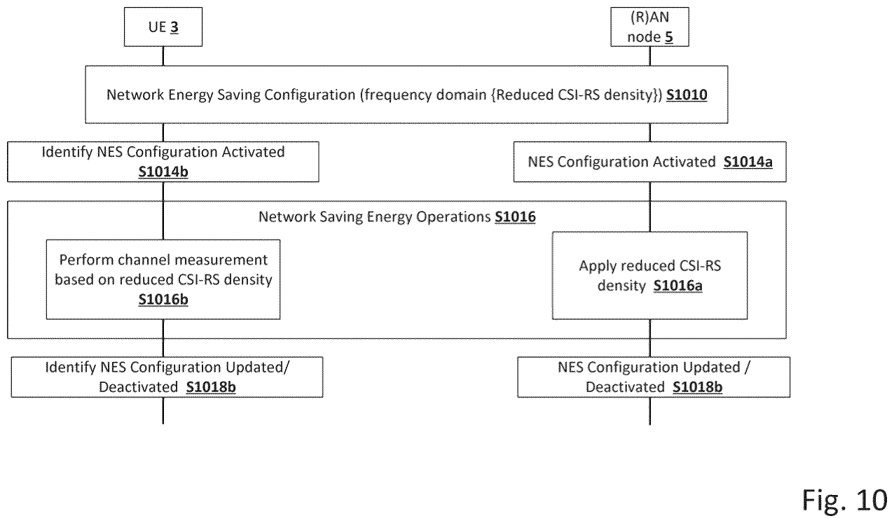

Another generalised method for configuring time domain network energy saving will now be described in more detail, by way of example only, with reference to FIG. 10.

FIG. 10 is a simplified timing diagram illustrating a procedure, which may be implemented in the telecommunication system 1 of FIG. 1, for configuring frequency domain network energy saving at the UE 3 (e.g., as part of the procedure of FIG. 5).

As seen in FIG. 10, the base station 5 provides (updated) NES configuration information to the UE 3 at S1010 which stores the information and responds appropriately (e.g., as described with reference to FIG. 5). In this example, the NES configuration information comprises frequency domain configuration information indicating that a reduced CSI-RS density will be used when the NES configuration is active. The reduced density can then be applied autonomously (at the base station 5 and UE 3) every time the base station 5 enters into the NES mode by activating the NES configuration, until the NES configuration is updated or deactivated.

The information indicating that a reduced CSI-RS density will be used may define the reduced CSI-RS density. The information indicating that a reduced CSI-RS density will be used may simply indicate that the CSI-RS density will be reduced without necessarily defining the density, in which case the density reduction may be preconfigured at the UE 3 and base station 5.

For example, the different supported densities may advantageously conform to the current densities for NZP-CSI-RS-Resources (e.g., 0.5 corresponding to every second resource block including one resource element allocated to the CSI signals; 1 corresponding to every resource block including one resource element allocated to the CSI signals; and 3 corresponding to every resource block including three resource elements allocated to the CSI signals). Then, when the NES configuration is activated, a reduced CSI-RS density may be applied automatically, such that density 3 becomes density 1, or density 1 becomes density 0.5. Alternatively, or additionally, a scaling factor may be included in the NES configuration information and automatically applied (for example a scaling factor of ⅓ may be configured to reduce the density from 3 to 1, or a scaling factor of ½ may be configured to reduce the density from 1 to 0.5).

When the NES configuration is then activated at the base station 5 (at S1014a) and UE 3 (at S1014b) (e.g., as described with reference to FIG. 5), the UE 5 is able to adapt its operations to take account of activation of the NES configuration appropriately. Specifically, once the NES configuration is activated at the base station 5 and UE 3, NES operations between the base station 5 and the UE 3 take place at S1016. For example, the base station 5 may apply the reduced CSI-RS density as seen at S1016a, and the UE 3 may perform reference signal measurements based on the reduced CSI-RS density (and associated reporting) at S1016b.

The NES operations continue until the NES configuration is deactivated (or updated) as indicated at S1018a and S1018b (e.g., as described with reference to FIG. 5).

### NES Bandwidth and UE-BWP Switching

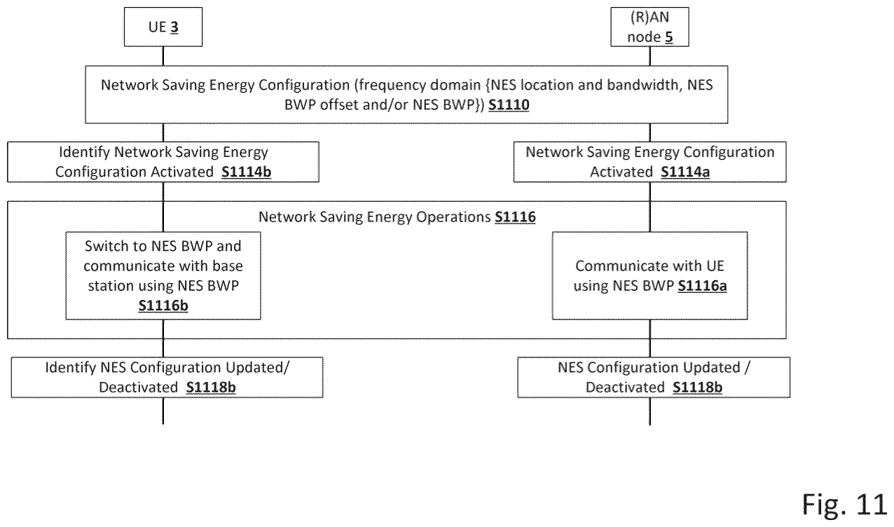

Another generalised method for configuring time domain network energy saving will now be described in more detail, by way of example only, with reference to FIG. 11.

FIG. 11 is a simplified timing diagram illustrating another procedure, which may be implemented in the telecommunication system 1 of FIG. 1, for configuring frequency domain network energy saving at the UE 3 (e.g., as part of the procedure of FIG. 5).

As seen in FIG. 11, the base station 5 provides (updated) NES configuration information to the UE 3 at S1110 which stores the information and responds appropriately (e.g., as described with reference to FIG. 5). In this example, the NES configuration information comprises frequency domain configuration information that defines a reduced NES bandwidth. The reduced NES bandwidth is, in this example defined by information identifying a start position relative to a first usable resource block (i.e., the ‘location’) in the frequency domain and the number of resource blocks in the reduced bandwidth (i.e., the ‘bandwidth’). While this information may be provided as separate parameters, the information may comprise a single ‘indication value’ from which both location and bandwidth may be derived.

The NES configuration in this example also includes information defining at least one NES BWP to be used by the UE. The information defining at least one NES BWP may define an effective NES BWP by specifying a start offset (e.g., an NESBWPoffset IE) which can be relative to the start position of the configured NES bandwidth) with the remaining parameters (e.g., configuring the length of the BWP, the CORESET, the CSI-RS etc.) reused from the existing BWP configuration, but shifted in the frequency domain by the offset. In this scenario, any part of the BWP/CORESET/CSI-RS which extends outside of the configured NES bandwidth will be excluded.

The information defining at least one NES BWP may include (e.g., in an NES BWP IE similar to a BWP-DL IE) information required to define a new UE specific NES BWP (e.g., including configurations for a CORESET, CSI-RS and/or the like) to be used when the active BWP of the UE needs to be changed for operation within the reduced NES bandwidth.

When the NES configuration is then activated at the base station 5 (at S1114a) and UE 3 (at S1114b) (e.g., as described with reference to FIG. 5), the UE 5 is able to adapt its operations to take account of activation of the NES configuration appropriately. Specifically, once the NES configuration is activated at the base station 5 and UE 3, NES operations between the base station 5 and the UE 3 take place at S1116 using the configured NES BWP within the reduced NES bandwidth. For example, the UE 3 may (if required because the active BWP extends beyond the NES bandwidth) switch to the NES BWP autonomously at S1116b and receive communication from the base station 5 within the NES BWP. Similarly, the base station 5 may use the NES BWP for communicating with the UE 3.

The NES operations continue until the NES configuration is deactivated (or updated) as indicated at S1118a and S1118b (e.g., as described with reference to FIG. 5).

It will, nevertheless, be appreciated that the NES BWP associated with the reduced NES bandwidth configuration may remain the same at any subsequent occurrence of an NES frequency configuration (without the need for an explicit BWP switching indication) as the NES BWP will be activated autonomously at the subsequent NES activation. This configured NES BWP will thus remain the same until the relevant NES reconfiguration.

It will be appreciated that, when NES is enabled and the default BWP for a particular UE 3 is no longer the active BWP, switching back to the default BWP may, beneficially, be inhibited. This may be done, for example, by redefining the new active NES BWP as the new default BWP during NES. Alternatively (or additionally), even where a UE is configured with a BWP inactivity timer, the UE 3 may be configured to stay on the current (NES) BWP without switching back to the default BWP for non-NES mode.

For a semi-persistent scheduling (SPS) PDSCH, and for Type-1 or Type-2 configured grant (CG) PUSCH, it will be appreciated that both the active BWP in non-NES mode and the active NES BWP in NES mode may be pre-configured, and BWP switching to the default NES-BWP can be carried out (by auto-switching), when a UE 3 enters or exits the NES mode (i.e., when the UE 3 identifies that NES has been activated at the base station 5), without the need of explicit activation or DCI indication.

### NES Bandwidth Scaling/Frequency Domain Pattern

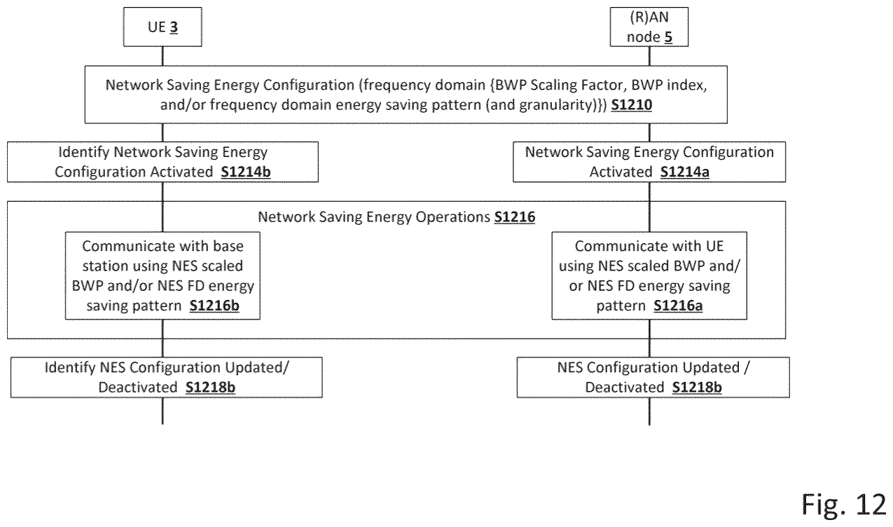

Another generalised method for configuring time domain network energy saving will now be described in more detail, by way of example only, with reference to FIG. 12.

FIG. 12 is a simplified timing diagram illustrating another procedure, which may be implemented in the telecommunication system 1 of FIG. 1, for configuring frequency domain network energy saving at the UE 3 (e.g., as part of the procedure of FIG. 5).

As seen in FIG. 12, the base station 5 provides (updated) NES configuration information to the UE 3 at S1210 which stores the information and responds appropriately (e.g., as described with reference to FIG. 5). In this example, the NES configuration information comprises frequency domain configuration information comprising information that defines one or more BWP scaling factors for implementing BWP bandwidths with a reduced bandwidth and/or information (e.g., a bitmap) that defines a frequency domain pattern for BWP adaptation when entering the NES mode. The NES configuration information comprising one or more scaling factors and frequency domain pattern information may be addressed to all UEs or to a ‘group’ of one or more UEs.

It will be appreciated that one or more scaling factors and/or frequency domain energy saving pattern may alternatively or additionally be provided in group common DCI or a media access control element (MAC CE) for faster (dynamic) activation/deactivation of an NES mode in which the scaling factor and/or frequency domain pattern is applied.

Additional flexibility for the frequency domain energy saving pattern may be provided by including information for configuring the energy saving pattern's granularity in the frequency domain configuration information. The granularity may, for example, be configured to be a number of (e.g., {1, 2, 4, 5, 8, 10 . . . }) resource block groups (RBGs), for supporting a scalable bitmap. The information for configuring the energy saving pattern's granularity may, for example, be in the form of an RBG group indication.

A respective bandwidth scaling factor may be configured to map each of a number of dedicated BWPs configured for a particular UE 3 to a respective NES BWP. For example, each UE 3 may effectively be preconfigured with a set of NES BWPs, each configured NES BWP having an associated BWP identifier or index (e.g., NESBWPID/BWPIndex) which correspond to a respective bandwidth scaling factor (e.g., ⅕, ¼, ⅓, ½ . . . and/or the like). The bandwidth scaling factor is used to map each new active NES BWP (identified by a corresponding new active BWP ID) to a respective existing BWP (identified by a corresponding existing BWP ID). For example, each UE 3 may be provided with a preconfigured mapping table in the NES config. Alternatively, the new active NES BWP to which BWP switching occurs may be determined implicitly (e.g., based on an implicit link to, or calculation based on, the existing BWP ID). An advantage of the ‘bandwidth scaling factor’ is that to enter into NES mode, no dedicated BWP switching signalling is needed for each individual UE.

When the NES configuration is then activated at the base station 5 (at S1214a) and UE 3 (at S1214b) (e.g., as described with reference to FIG. 5), the UE 5 is able to adapt its operations to take account of activation of the NES configuration appropriately. Specifically, once the NES configuration is activated at the base station 5 and UE 3, NES operations between the base station 5 and the UE 3 take place at S1216 using a scaled NES BWP and/or the NES frequency domain energy saving pattern. Specifically, the base station 5 may use the scaled NES BWP and/or the NES frequency domain energy saving pattern for communicating with the UE 3 at S1216a. Similarly, the UE 3 receives communications from the base station 5 using the scaled NES BWP and/or the NES frequency domain energy saving pattern at S1316b.

The NES operations continue until the NES configuration is deactivated (or updated) as indicated at S1218a and S1218b (e.g., as described with reference to FIG. 5).

It will be appreciated that rather than reconfigure CORESET, CSI-RS etc., the part of configured CORESET, CSI-RS etc. which extends outside the scaled BWP may simply be excluded.

### Spatial Domain Network Energy Saving

### Transceiver ON/OFF Configuration

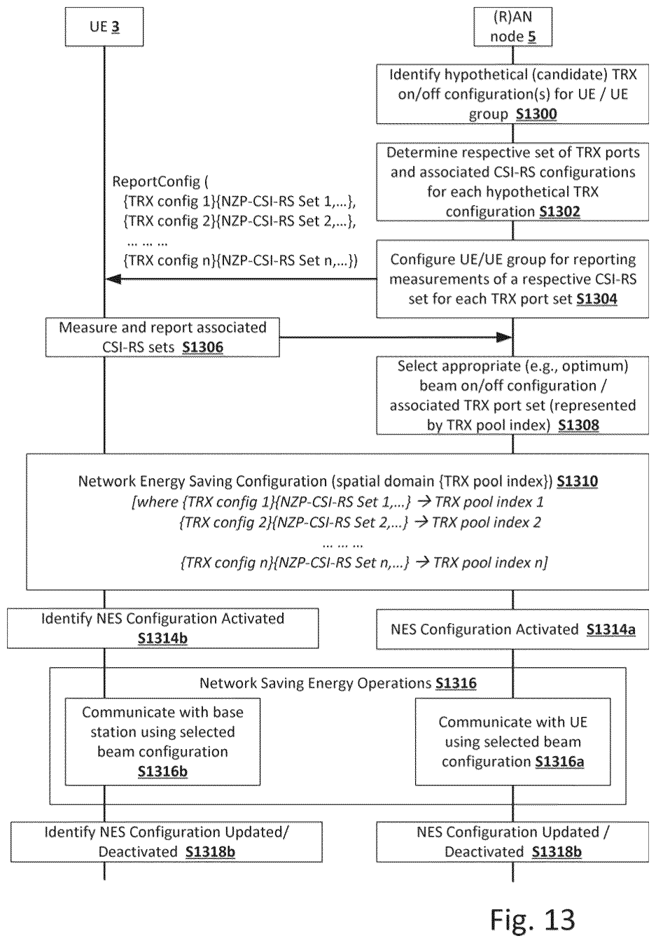

Another generalised method for configuring time domain network energy saving will now be described in more detail, by way of example only, with reference to FIG. 13.

FIG. 13 is a simplified timing diagram illustrating another procedure, which may be implemented in the telecommunication system 1 of FIG. 1, for configuring spatial domain network energy saving at the UE 3 (e.g., as part of the procedure of FIG. 5).

As seen in FIG. 13, the base station 5 generates (at S1300) one or more hypothetical transceiver (TRX) on/off configurations, for a group of one or more UEs. The base station 5 uses the hypothetical TRX on/off configurations (at S1302) to determine an appropriate TRX configuration for network energy saving. A respective set of ports (such as 64/32/8/4) and one or more associated CSI-RS configurations can then be determined for each hypothetical TRX on/off configuration. The base station 5 then configures (at S1304) the UE/UE group for reporting measurements of CSI-RS (e.g., using a reportconfig IE). The UE 3 measures the configured CSI-RS sets and reports the results at S1306. The base station 5 identifies the best of the directional beams, and selects the associated TRX ports, to turn on/off based on the reported measurements at S1308.

The TRX configuration for NES can then be (re)configured by mapping the selected TRX ports setting to an associated index (e.g., a TrxPoolIndex IE) in spatial domain configuration information provided as part of the NES configuration. A field for the index is included, for each group of NZP-CSI-RS configurations for reference signal resource configuration and measurement reporting, in the information for configuring CSI reporting (e.g., the reportConfig IE) sent to the UE 3. By way of illustration, the index may, for example, be mapped as follows:

{TRX config 1} {NZP-CSI-RS Set 1, ... } to TrxPoolIndex_1
{TRX config 2} {NZP-CSI-RS Set 2, ... } to TrxPoolIndex_1
...
{TRX config n} {NZP-CSI-RS Set n, ... } to TrxPoolIndex_m

The base station 5 provides the (updated) NES configuration information to the UE 3 at S1310 which stores the information and responds appropriately (e.g., as described with reference to FIG. 5). The NES configuration information may include information identifying a specific transceiver port setting for an energy saving beam configuration (e.g., TRX ports (64/32/8/4) IE that identifies the number of antennas to be turned off) and information identifying the CSI-RS configurations associated with each of the antenna ports (e.g., in a CSI-RS configuration (ON/OFF) IE). In this context, the index (TrxPoolIndex) identifies the association between CSI-RS configuration and antenna ports, in order to optimise the capacity performance under network energy saving. The presence of the index effectively ensures that the UE 3 and the base station 5 have the same understanding.

When the NES configuration is then activated at the base station 5 (at S1314a) and UE 3 (at S1314b) (e.g., as described with reference to FIG. 5), the UE 5 is able to adapt its communications to take account of activation of the NES configuration appropriately. Specifically, once the NES configuration is activated at the base station 5 and UE 3, NES operations between the base station 5 and the UE 3 take place at S1316 using the selected beam configuration. Specifically, the base station 5 implements the selected beam configuration and uses it for communicating with the UE 3 at S1316a. Similarly, the UE 3 receives communications from the base station 5 using the selected beam configuration at S1316b.

The NES operations continue until the NES configuration is deactivated (or updated) as indicated at S1318a and S1318b (e.g., as described with reference to FIG. 5).

It will be appreciated that, in the uplink, a similar technique can be implemented for measurement, at the base station 5, of SRS transmitted by the UE 3. Specifically, a respective SRS index (e.g., SrsPoolIndex) may be used for SRS resource configuration and associated measurement acquisition with network energy saving enabled. The SRS index may be associated with each of a plurality of uplink receiver (Rx) port configurations for Rx ‘On/Off’. In a similar manner to downlink CSI-RS, the base station 5 can generate one or more hypothetical RX on/off configurations, which can be used for determining an appropriate RX configuration to be used for network energy saving.

A respective set of ports and one or more associated SRS resource configurations can then be determined for each hypothetical RX on/off configuration. The base station measures respective SRS corresponding to the RX configuration, allowing the base station 5 to select the best RX ports to turn on/off. The selected RX ports setting can then be notified to the UE 3 in the spatial domain configuration information provided as part of the NES configuration. Hence the UE 3 is able to identify which energy saving SRS resource configurations to use for uplink SRS.

### Modifications and Alternatives

Detailed examples have been described above along with a number of variations and alternatives. As those skilled in the art will appreciate, a number of modifications and alternatives can be made to the above examples whilst still benefiting from the disclosures embodied therein.

It will be appreciated, for example, that whilst cellular communication generation (2G, 3G, 4G, 5G, 6G etc.) specific terminology may be used, in the interests of clarity, to refer to specific communication entities, the technical features described for a given entity are not limited to devices of that specific communication generation. The technical features may be implemented in any functionally equivalent communication entity regardless of any differences in the terminology used to refer to them.

In the above description, the UEs and the base station are described for ease of understanding as having a number of discrete functional components or modules. Whilst these modules may be provided in this way for certain applications, for example where an existing system has been modified to implement the disclosure, in other applications, for example in systems designed with the inventive features in mind from the outset, these modules may be built into the overall operating system or code and so these modules may not be discernible as discrete entities.

In the above example embodiments, a number of software modules were described. As those skilled in the art will appreciate, the software modules may be provided in compiled or un-compiled form and may be supplied to the base station, to the mobility management entity, or to the UE as a signal over a computer network, or on a recording medium. Further, the functionality performed by part or all of this software may be performed using one or more dedicated hardware circuits. However, the use of software modules is preferred as it facilitates the updating of the base station or the UE in order to update their functionalities.

Each controller may comprise any suitable form of processing circuitry including (but not limited to), for example: one or more hardware implemented computer processors; microprocessors; central processing units (CPUs); arithmetic logic units (ALUs); input/output (IO) circuits; internal memories/caches (program and/or data); processing registers; communication buses (e.g. control, data and/or address buses); direct memory access (DMA) functions; hardware or software implemented counters, pointers and/or timers; and/or the like. Various other modifications will be apparent to those skilled in the art and will not be described in further detail here.

The base station may comprise a ‘distributed’ base station having a central unit ‘CU’ and one or more separate distributed units (DUs).

The User Equipment (or “UE”, “mobile station”, “mobile device” or “wireless device”) in the present disclosure is an entity connected to a network via a wireless interface.

It should be noted that the present disclosure is not limited to a dedicated communication device and can be applied to any device having a communication function as explained in the following paragraphs.

The terms “User Equipment” or “UE” (as the term is used by 3GPP), “mobile station”, “mobile device”, and “wireless device” are generally intended to be synonymous with one another, and include standalone mobile stations, such as terminals, cell phones, smart phones, tablets, cellular IoT devices, IoT devices, and machinery. It will be appreciated that the terms “mobile station” and “mobile device” also encompass devices that remain stationary for a long period of time.

A UE may, for example, be an item of equipment for production or manufacture and/or an item of energy related machinery (for example equipment or machinery such as: boilers; engines; turbines; solar panels; wind turbines; hydroelectric generators; thermal power generators; nuclear electricity generators; batteries; nuclear systems and/or associated equipment; heavy electrical machinery; pumps including vacuum pumps; compressors; fans; blowers; oil hydraulic equipment; pneumatic equipment; metal working machinery; manipulators; robots and/or their application systems; tools; molds or dies; rolls; conveying equipment; elevating equipment; materials handling equipment; textile machinery; sewing machines; printing and/or related machinery; paper converting machinery; chemical machinery; mining and/or construction machinery and/or related equipment; machinery and/or implements for agriculture, forestry and/or fisheries; safety and/or environment preservation equipment; tractors; precision bearings; chains; gears; power transmission equipment; lubricating equipment; valves; pipe fittings; and/or application systems for any of the previously mentioned equipment or machinery etc.).

A UE may, for example, be an item of transport equipment (for example transport equipment such as: rolling stocks; motor vehicles; motorcycles; bicycles; trains; buses; carts; rickshaws; ships and other watercraft; aircraft; rockets; satellites; drones; balloons etc.).

A UE may, for example, be an item of information and communication equipment (for example information and communication equipment such as: electronic computer and related equipment; communication and related equipment; electronic components etc.).

A UE may, for example, be a refrigerating machine, a refrigerating machine applied product, an item of trade and/or service industry equipment, a vending machine, an automatic service machine, an office machine or equipment, a consumer electronic and electronic appliance (for example a consumer electronic appliance such as: audio equipment; video equipment; a loud speaker; a radio; a television; a microwave oven; a rice cooker; a coffee machine; a dishwasher; a washing machine; a dryer; an electronic fan or related appliance; a cleaner etc.).

A UE may, for example, be an electrical application system or equipment (for example an electrical application system or equipment such as: an x-ray system; a particle accelerator; radio isotope equipment; sonic equipment; electromagnetic application equipment; electronic power application equipment etc.).

A UE may, for example, be an electronic lamp, a luminaire, a measuring instrument, an analyser, a tester, or a surveying or sensing instrument (for example a surveying or sensing instrument such as: a smoke alarm; a human alarm sensor; a motion sensor; a wireless tag etc.), a watch or clock, a laboratory instrument, optical apparatus, medical equipment and/or system, a weapon, an item of cutlery, a hand tool, or the like.

A UE may, for example, be a wireless-equipped personal digital assistant or related equipment (such as a wireless card or module designed for attachment to or for insertion into another electronic device (for example a personal computer, electrical measuring machine)).

A UE may be a device or a part of a system that provides applications, services, and solutions described below, as to “internet of things (IoT)”, using a variety of wired and/or wireless communication technologies.

Internet of Things devices (or “things”) may be equipped with appropriate electronics, software, sensors, network connectivity, and/or the like, which enable these devices to collect and exchange data with each other and with other communication devices. IoT devices may comprise automated equipment that follow software instructions stored in an internal memory. IoT devices may operate without requiring human supervision or interaction. IoT devices might also remain stationary and/or inactive for a long period of time. IoT devices may be implemented as a part of a (generally) stationary apparatus. IoT devices may also be embedded in non-stationary apparatus (e.g. vehicles) or attached to animals or persons to be monitored/tracked.

It will be appreciated that IoT technology can be implemented on any communication devices that can connect to a communications network for sending/receiving data, regardless of whether such communication devices are controlled by human input or software instructions stored in memory.

It will be appreciated that IoT devices are sometimes also referred to as Machine-Type Communication (MTC) devices or Machine-to-Machine (M2M) communication devices. It will be appreciated that a UE may support one or more IoT or MTC applications. Some examples of MTC applications are listed in the following table. This list is not exhaustive and is intended to be indicative of some examples of machine-type communication applications.

| Service Area | MTC applications |
|---|---|
| Security | Surveillance systems |
| | Backup for landline |
| | Control of physical access |
| | (e.g. to buildings) |
| | Car/driver security |
| Tracking & Tracing | Fleet Management |
| | Order Management |
| | Pay as you drive |
| | Asset Tracking |
| | Navigation |
| | Traffic information |
| | Road tolling |
| | Road traffic optimisation/steering |
| Payment | Point of sales |
| | Vending machines |
| | Gaming machines |
| Health | Monitoring vital signs |
| | Supporting the aged or handicapped |
| | Web Access Telemedicine points |
| | Remote diagnostics |
| Remote Maintenance/ | Sensors |
| Control | Lighting |
| | Pumps |
| | Valves |
| | Elevator control |
| | Vending machine control |
| | Vehicle diagnostics |
| Metering | Power |
| | Gas |
| | Water |
| | Heating |
| | Grid control |
| | Industrial metering |
| Consumer Devices | Digital photo frame |
| | Digital camera |
| | eBook |

Applications, services, and solutions may be an MVNO (Mobile Virtual Network Operator) service, an emergency radio communication system, a PBX (Private Branch eXchange) system, a PHS/Digital Cordless Telecommunications system, a POS (Point of sale) system, an advertise calling system, an MBMS (Multimedia Broadcast and Multicast Service), a V2X (Vehicle to Everything) system, a train radio system, a location related service, a Disaster/Emergency Wireless Communication Service, a community service, a video streaming service, a femto cell application service, a VoLTE (Voice over LTE) service, a charging service, a radio on demand service, a roaming service, an activity monitoring service, a telecom carrier/communication NW selection service, a functional restriction service, a PoC (Proof of Concept) service, a personal information management service, an ad-hoc network/DTN (Delay Tolerant Networking) service, etc.

Further, the above-described UE categories are merely examples of applications of the technical ideas and exemplary example embodiments described in the present document. Needless to say, these technical ideas and example embodiments are not limited to the above-described UE and various modifications can be made thereto.

Various other modifications will be apparent to those skilled in the art and will not be described in further detail here.

The whole or part of the example embodiments disclosed above can be described as, but not limited to, the following supplementary notes.

### (Supplementary Note 1)

A method performed by a user equipment (UE), the method comprising:
receiving, from an access network node, at least one network energy saving configuration for energy saving at the access network node;
identifying when the at least one network energy saving configuration has been activated; and
configuring operation of the UE, based on the at least one network energy saving configuration, and when the at least one network energy saving configuration has been activated.

### (Supplementary Note 2)

The method according to Supplementary note 1, wherein the at least one network energy saving configuration includes at least one of:
at least one time domain configuration including a configuration of at least one time domain resource for energy saving at the access network node;
at least one frequency domain configuration including a configuration of at least one frequency domain resource for energy saving at the access network node;
at least one spatial domain configuration including a transmitter or receiver configuration to be applied at the access network node to provide energy saving; and
at least one power domain configuration including a power configuration to be applied at the access network node to provide energy saving.

### (Supplementary Note 3)

The method according to Supplementary note 2, wherein, in a case that the at least one network energy saving configuration includes at least one time domain configuration, the at least one time domain configuration defines at least one time period during which the at least one network energy saving configuration will be active.

### (Supplementary Note 4)

The method according to Supplementary note 3, wherein the at least one time domain configuration includes an indication of at least one of:
at least one periodicity of the at least one time period;
at least one offset representing a start time of the at least one time period;
at least one granularity for the at least one time period;
at least one duration of the at least one time period;
at least one timer value for timing the at least one time period; or
at least one time of day corresponding to the at least one time period.

### (Supplementary Note 5)

The method according to Supplementary note 3 or 4, wherein the at least one time domain configuration includes timing information indicating at least one part of the of the at least one time period during which network energy saving will be active or inactive.

### (Supplementary Note 6)

The method according to Supplementary note 5, wherein the timing information indicates at least one pattern of time domain resources within the at least one time period during which network energy saving will be active or inactive.

### (Supplementary Note 7)

The method according to Supplementary note 6, wherein the timing information includes at least one bitmap to indicate the at least one pattern of time domain resources.

### (Supplementary Note 8)

The method according to Supplementary note 6 or 7, wherein the timing information includes at least one offset to indicate a start of the at least one pattern of time domain resources.

### (Supplementary Note 9)

The method according to any of Supplementary notes 5 to 8, wherein the at least one time domain configuration includes a granularity for the timing information.

### (Supplementary Note 10)

The method according to any of Supplementary notes 3 to 9, wherein the at least one network energy saving configuration includes a plurality of time domain configurations, each time domain configuration of the plurality of time domain configurations defining a respective time period during which that network energy saving configuration will be active, wherein the respective time period defined by each of the plurality of time domain configurations has a different respective periodicity.

### (Supplementary Note 11)

The method according to any of Supplementary notes 3 to 10, further comprising:
determining if a reference signal to be measured will coincide with a time during which network energy saving is active; and
in a case where a reference signal to be measured will coincide with a time during which network energy saving is active, excluding the reference signal to be measured from measurement.

### (Supplementary Note 12)

The method according to any of Supplementary notes 3 to 11, further comprising:
determining if a reference signal to be transmitted will coincide with a time during which network energy saving is active; and
in a case where a reference signal to be transmitted will coincide with a time during which network energy saving is active, excluding the reference signal to be transmitted from transmission.

### (Supplementary Note 13)

The method according to any of Supplementary notes 1 to 12 wherein the at least one network energy saving configuration includes an indication of a time at which the at least one network energy saving configuration will activated, and the identifying is based on the indication of the time at which the at least one network energy saving configuration will activated.

### (Supplementary Note 14)

The method according to any of Supplementary notes 1 to 13, wherein, in a case that the at least one network energy saving configuration includes at least one frequency domain configuration, the at least one frequency domain configuration defines a reconfiguration of at least one frequency resource that will be applied in a case where the at least one network energy saving configuration is active.

### (Supplementary Note 15)

The method according to Supplementary note 14, wherein the at least one frequency domain configuration includes an indication that a reduced reference signal density will be applied in a case where the at least one network energy saving configuration is active.

### (Supplementary Note 16)

The method according to Supplementary note 14 or 15, wherein the indication that a reduced reference signal density will be applied indicates a density scaling factor that is to be applied to a current reference signal density to arrive at the reduced reference signal density.

### (Supplementary Note 17)

The method according to any of Supplementary notes 14 to 16, wherein the at least one frequency domain configuration indicates at least one reduced bandwidth that is to be applied in a case where the at least one network energy saving configuration is active.

### (Supplementary Note 18)

The method according to Supplementary note 17, wherein the at least one frequency domain configuration includes a frequency offset indicating a start position of a bandwidth to be used by the UE within the at least one reduced bandwidth.

### (Supplementary Note 19)

The method according to any of Supplementary notes 14 to 18, wherein the at least one frequency domain configuration indicates a UE specific bandwidth part that is to be used in a case where the at least one network energy saving configuration is active.

### (Supplementary Note 20)

The method according to any of Supplementary notes 14 to 19, wherein the at least one frequency domain configuration indicates at least one bandwidth part scaling factor that is to be applied in respect of at least one bandwidth part to arrive at the at least one reduced bandwidth.

### (Supplementary Note 21)

The method according to Supplementary note 20, wherein the at least one frequency domain configuration indicates a mapping between the at least one bandwidth part scaling factor and the at least one bandwidth part in respect of which the bandwidth part scaling factor is to be applied.

### (Supplementary Note 22)

The method according to any of Supplementary notes 14 to 21, wherein the at least one frequency domain configuration indicates at least one pattern of frequency domain resources which are to be active or inactive in a case where the at least one network energy saving configuration is active.

### (Supplementary Note 23)

The method according to Supplementary note 22, wherein the at least one frequency domain configuration includes at least one bitmap to indicate the pattern of frequency domain resources.

### (Supplementary Note 24)

The method according to Supplementary note 22 or 23, wherein the at least one frequency domain configuration includes a granularity for the pattern of frequency domain resources.

### (Supplementary Note 25)

The method according to any of Supplementary notes 1 to 24, wherein
the UE is configured with a default bandwidth part, and wherein,
in a case where the default bandwidth part is not a currently active bandwidth part, the configuring includes redefining a currently active bandwidth part configured for network energy saving as a new default bandwidth part.

### (Supplementary Note 26)

The method according to any of Supplementary notes 1 to 24, wherein
the UE is configured with a default bandwidth part and an inactivity timer for timing a period of inactivity after which the UE is configured to switch back to the default bandwidth part, and wherein,
in a case where the default bandwidth part is not a currently active bandwidth part, the configuring includes inhibiting operation of the inactivity timer to cause the UE to continue to use a currently active bandwidth part configured for network energy saving.

### (Supplementary Note 27)

The method according to any of Supplementary notes 1 to 26, wherein the UE is configured with at least one first bandwidth part for use in a case where network energy saving is not active, and at least one second bandwidth part for use in a case where network energy saving is active, and wherein the configuring includes switching from at least one first bandwidth part to at least one second bandwidth part.

### (Supplementary Note 28)

The method according to any of Supplementary notes 1 to 27, further comprising:
receiving, from the access network node, a reference signal reporting configuration indicating at least one reference signal set for reporting to the access network node, and at least one transceiver configuration associated with the at least one reference signal set;
measuring the at least one reference signal set; and
reporting a result of the measuring to the access network node;
wherein, in a case that the at least one network energy saving configuration includes at least one spatial domain configuration, the at least one spatial domain configuration indicates at least one transceiver configuration selected by the access network node for network energy saving based on measurements reported by the UE for at least one reference signal set associated with the at least one transceiver configuration selected by the access network node.

### (Supplementary Note 29)

The method according to any of Supplementary notes 1 to 28, further comprising:
receiving, from the access network node, a reference signal resource configuration indicating at least one resource set for transmission of at least one set of reference signals, and at least one receiver configuration associated with the at least one set of reference signals;
transmitting, to the access network node, the at least one set of reference signals using the at least one resource set;
wherein, in a case that the at least one network energy saving configuration includes at least one spatial domain configuration, the at least one spatial domain configuration indicates at least one receiver configuration selected by the access network node for network energy saving based on measurements of at least one set of reference signals, transmitted by the UE, associated with the at least one receiver configuration selected by the access network node.

### (Supplementary Note 30)

The method according to any of Supplementary notes 1 to 29, wherein in a case that the at least one network energy saving configuration includes at least one power domain configuration, the at least one power domain configuration indicates at least one of a power scaling factor, or a sleep mode type, to be applied at the access network node for network energy saving.

### (Supplementary Note 31)

The method according to any of Supplementary notes 1 to 30, wherein the at least one network energy saving configuration includes at least one joint configuration indicating a mapping between a plurality of different configurations, the plurality of different configurations including at least two configurations of:
a time domain configuration;
a frequency domain configuration;
a spatial domain configuration; or
a power domain configuration.

### (Supplementary Note 32)

A user equipment (UE) comprising:
means for receiving, from an access network node, at least one network energy saving configuration for energy saving at the access network node;
means for identifying when the at least one network energy saving configuration has been activated; and
means for configuring operation of the UE, based on the at least one network energy saving configuration, and when the at least one network energy saving configuration has been activated.

### (Supplementary Note 33)

A method performed by an access network node, the method comprising:
transmitting, to a user equipment (UE), at least one network energy saving configuration for energy saving at the access network node;
identifying when the at least one network energy saving configuration is to be activated;
activating the at least one network energy saving configuration; and
configuring operation of the access network node, based on the at least one network energy saving configuration transmitted to the UE.

### (Supplementary Note 34)

An access network node comprising:
means for transmitting, to a user equipment (UE), at least one network energy saving configuration for energy saving at the access network node;
means for identifying when the at least one network energy saving configuration is to be activated;
means for activating the at least one network energy saving configuration; and
means for configuring operation of the access network node, based on the at least one network energy saving configuration transmitted to the UE.

This application is based upon and claims the benefit of priority from United Kingdom patent application No. 2209589.7, filed on Jun. 29, 2022, the disclosure of which is incorporated herein in its entirety by reference.

### REFERENCE SIGNS LIST

3 UE
5 radio access network (RAN) node
7 core network
9 cell
10 CPF
11 UPF

What is claimed is:

1-33. (canceled)

34. A method performed by a user equipment (UE), the method comprising:
receiving, from an access network node, measurement configuration information related to network energy saving at the access network node; and
configuring operation of the UE for a measurement of a reference signal, based on the measurement configuration information, and
wherein the measurement configuration information includes at least one subconfiguration information indicating at least one of:
a spatial domain configuration; or
a power domain configuration.

35. The method according to claim 34, wherein, in a case where the measurement configuration information indicates a spatial domain configuration, the spatial domain configuration indicates at least one set of ports.

36. The method according to claim 34, wherein
the measurement configuration information includes information indicating at least one resource for measurements of the reference signal.

37. The method according to claim 34, further comprising:
receiving information for activating or deactivating at least one network energy saving configuration at the access network node, and wherein
the configuring is performed based on at least one activated or deactivated network energy saving configuration at the access network node.

38. The method according to claim 37, wherein
the information for activating or deactivating the at least one network energy saving configuration indicates activation or deactivation of a plurality of network energy saving configuration simultaneously.

39. The method according to claim 37, wherein
the information for activating or deactivating the at least one network energy saving configuration is transmitted in at least one of Downlink Control Information (DCI) and a Media Access Control-Control Element (MAC-CE).

40. The method according to claim 34, wherein
the reference signal includes at least one of:
a Channel State Information-Reference Signal (CSI-RS), and
a Sounding Reference Signal (SRS).

41. A user equipment (UE) comprising:
at least one memory storing instructions; and
at least one processor configured to execute the instructions to:
receive, from an access network node, measurement configuration information related to network energy saving at the access network node; and
configure operation of the UE for a measurement of a reference signal, based on the measurement configuration information, and
wherein the measurement configuration information includes at least one subconfiguration information indicating at least one of:
a spatial domain configuration; or
a power domain configuration.

42. The UE according to claim 41, wherein, in a case where the measurement configuration information indicates a spatial domain configuration, the spatial domain configuration indicates at least one set of ports.

43. The UE according to claim 41, wherein
the measurement configuration information includes information indicating at least one resource for measurements of the reference signal.

44. The UE according to claim 41, the at least one processor is configured to execute the instructions to:
receive information for activating or deactivating at least one network energy saving configuration at the access network node; and
configure operation of the UE for the measurement of the reference signal based on at least one activated or deactivated network energy saving configuration at the access network node.

45. The UE according to claim 44, wherein
the information for activating or deactivating the at least one network energy saving configuration indicates activation or deactivation of a plurality of network energy saving configuration simultaneously.

46. A method performed by an access network node, the method comprising:
transmitting, to a user equipment (UE), measurement configuration information related to network energy saving at the access network node, the measurement configuration information causes the UE to configure operation of the UE for a measurement of a reference signal, based on the measurement configuration information, and
wherein the measurement configuration information includes at least one subconfiguration information indicating at least one of:
a spatial domain configuration; or
a power domain configuration.

47. The method according to claim 46, wherein, in a case where the measurement configuration information indicates a spatial domain configuration, the spatial domain configuration indicates at least one set of ports.

48. The method according to claim 46, wherein
the measurement configuration information includes information indicating at least one resource for measurements of the reference signal.

49. The method according to claim 46, further comprising:
transmitting, to the UE, information for activating or deactivating at least one network energy saving configuration at the access network node, and wherein
the UE configures operation of the UE for the measurement of the reference signal based on at least one activated or deactivated network energy saving configuration at the access network node.

50. The method according to claim 49, wherein
the information for activating or deactivating the at least one network energy saving configuration indicates activation or deactivation of a plurality of network energy saving configuration simultaneously.

51. The method according to claim 49, wherein
the information for activating or deactivating the at least one network energy saving configuration is transmitted in at least one of Downlink Control Information (DCI) and a Media Access Control-Control Element (MAC-CE).

52. The method according to claim 46, wherein
the reference signal includes at least one of:
a Channel State Information-Reference Signal (CSI-RS), and
a Sounding Reference Signal (SRS)

53. An access network node comprising:
at least one memory storing instructions; and
at least one processor configured to execute the instructions to:
transmit, to a user equipment (UE), measurement configuration information related to network energy saving at the access network node, the measurement configuration information causes the UE to configure operation of the UE for a measurement of a reference signal, based on the measurement configuration information, and
wherein the measurement configuration information includes at least one subconfiguration information indicating at least one of:
a spatial domain configuration; or
a power domain configuration.
